(19) United States
(12) Patent Application Publication
(10) Pub. No.: US 2018/0037803 A1
(43) Pub. Date: Feb. 8, 2018

(54) METHODS OF TREATING OIL AND GAS WELL FRACTURES

(71) Applicant: BOARD OF SUPERVISORS OF LOUISIANA STATE UNIVERITY AND AGRICULTURAL AND MECHAN, Baton Rouge, LA (US)

(72) Inventors: Arash Dahi Taleghani, Baton Rouge, LA (US); Guoqiang Li, Baton Rouge, LA (US)

(21) Appl. No.: 15/668,957

(22) Filed: Aug. 4, 2017

Related U.S. Application Data
(60) Provisional application No. 62/370,973, filed on Aug. 4, 2016.

(51) Int. Cl. C09K 8/516; E21B 37/00; E21B 21/00; E21B 33/138

(52) U.S. Cl. CPC C09K 8/516; E21B 33/138; E21B 37/00; E21B 21/003; C09K 2208/08

(57) ABSTRACT

Embodiments of the present disclosure provide for loss circulation materials, methods of making loss circulation materials, methods treating oil and gas well fractures using loss circulation materials, and the like.

### CROSS-REFERENCE TO RELATED APPLICATIONS

This application claims the benefit of and priority to U.S. Provisional Application Ser. No. 62/370,973, having the title “METHODS OF TREATING OIL AND GAS WELL FRACTURES”, filed on Aug. 4, 2016, the disclosure of which is incorporated herein in by reference in its entirety.

### BACKGROUND

Presence of pre-existing fractures in the subsurface as well as the mudweight inside a well may provide a flow path for the drilling mud to leave the well. Loss of circulation is defined as the uncontrolled flow of borehole fluid into a formation which is sometimes referred to as a “thief zone.” In partial lost circulation, drilling mud keeps circulating to surface with some loss to the formation. Total lost circulation, however, takes place when all the mud leaks into a formation with no return to the pit at the surface. This situation may ends up with serious blowout events. There are several conditions that can be responsible for the lost circulation: Formations that are naturally fractured, vugular, or have brittle rock, or improper drilling conditions or because of fractures initiated by excessive downhole pressures and setting intermediate casing too shallow. The complete prevention of lost circulation is not conceivable, because basically some formations, such as naturally fractured zones, are not avoidable if the target zone is located below them. However, limiting circulation loss is possible if certain precautions are taken, especially those related to drilling induced fractures. If lost-circulation zones are anticipated, preventive measures should be taken and preventive tests such as the formation integrity test should be performed to better define the mudweight window to limit the possibility of loss of circulation.

Lost circulation has been one of the major challenges that cause much nonproductive time (NPT) each year, including the cost of rig time and all the services that support the drilling operation. Its impact on well construction costs is significant, representing an estimated $2 to 4 billion annually (Growcock, F., 2010). The US Department of Energy reports that on average 10% to 20% of the cost of drilling high-pressure, high temperature wells is expended on mud losses. Losing mud into the oil or gas reservoir can drastically reduce the operator's ability to produce the zone. Depending on the severity of losses, various preventive and remedial treatments need to be tested in the laboratory before operated in the fields.

Setting up cementing and casing to seal the loss zone had been a conventional treatment. However, this solution is expensive, limits future drilling options and may compromise logging opportunities. Available data (Wang, H. et al., 2008) indicates that up to 45% of all wells in the 339 fields require intermediate casing or drilling liner strings to isolate loss zones and even after using these extra pipe strings, lost circulation events still occurred in 18% to 26% of all the hoe sections drilled and even from 40% to 80% for some wells. In recent years, industry operators have intensified their projects for deeper reservoirs and drilled through depleted or partially depleted formation. This trend made the above percentage increase. On the other hand, industry metrics show that the percentage of nonproductive time (NPT) to drill time increases significantly as water depth increases (Pritchard et al., 2012). The drilling cost due to lost circulation would increase as lost circulation is one of the main causes to NPT, based on the deep wells data drilled in the US Gulf of Mexico deep-water and ultra-deep-water through September 2004 to August 2010 (Table 1 below). So far, nearly 200 lost circulation materials (LCM) products have been offered by 50 drilling fluid companies to control lost circulation (Growcock, F., 2010). Unfortunately, conventional LCMs have reached their limits and been unsuccessful. To solve these issues, a novel and comprehensive LCM and lost circulation control program should be paid significant attentions.

### SUMMARY

Embodiments of the present disclosure provide for loss circulation materials, methods of making loss circulation materials, methods treating oil and gas well fractures using loss circulation materials, and the like.

In an aspect, the present disclosure provides for a method of reducing loss circulation in an oil and gas well, among others, that includes: disposing a loss circulation material including a shape memory polymer in a programed state into fractures in a well during drilling, wherein the shape memory polymer has an activated state and a programed state, wherein in the programed state of the shape memory polymer has a first diameter, wherein in the activated state of the shape memory polymer has a second diameter, wherein the second diameter is greater than the first diameter, wherein the shape memory polymer in the programed state will convert to the shape memory polymer in the activated state when a first temperature is applied to the shape memory polymer in the programed state, wherein the loss circulation material is exposed to the first temperature in the oil and gas well; exposing the loss circulation material to the first temperature converts the shape memory polymer in the programed state to the shape memory polymer in the activated state upon, wherein the expansion of the shape memory polymer fills a portion of the fracture, wherein a subsequent change in the temperature of the oil and gas well to be different than the first temperature does not alter the activated state of the shape memory polymer; and reducing the loss circulation in the oil and gas well.

In an aspect, the present disclosure provides for a method of strengthening a wellbore in an oil and gas well, among others, that includes: disposing a loss circulation material including a shape memory polymer in a programed state into fractures in a well during drilling, wherein the shape memory polymer has an activated state and a programed state, wherein in the programed state of the shape memory polymer has a first diameter, wherein in the activated state of the shape memory polymer has a second diameter, wherein the second diameter is greater than the first diameter, wherein the shape memory polymer in the programed state will convert to the shape memory polymer in the activated state when a first temperature is applied to the shape memory polymer in the programed state, wherein the loss circulation material is exposed to the first temperature in the oil and gas well; and exposing the loss circulation material to the first temperature converts the shape memory polymer in the programed state to the shape memory polymer in the activated state upon, wherein the expansion of the shape memory polymer fills a portion of the fracture, wherein a subsequent change in the temperature of the oil and gas well to be different than the first temperature does not alter the activated state of the shape memory polymer, wherein expansion of the shape memory polymer strengthens the wellbore relative to the strength prior to expansion of the shape memory polymer.

Other compositions, apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 provides schematics for partial and total lost-circulation zones.

FIG. 2 illustrates a typical thermomechanical cycle for SMP and SMP foam, figure after (Li and Nettles 2010).

FIG. 3 is an example of a manufacturing, programming and shape recovery cycle for Shape Memory Polymers (SMP)-based lost circulation materials (LCMs).

FIGS. 4A-B show a filled fracture with SMP particles (4A) before and (4B) after activation. Deformed particles would isolate the fracture from the surrounding formation.

FIG. 5 is a schematic of an apparatus used to verify the functionality of the LCM.

FIG. 6 is a photograph of a cell loaded with LCM before the expansion.

FIG. 7 shows LCM after the expansion, effectively sealing the fracture.

FIG. 8 is a graphical representation of an embodiement of the thermomechanical Cycle for Thermoset SMP.

FIG. 9 is an example of a high-pressure and high-temperature permeability plugging apparatus with LCM Receiver.

FIG. 10A shows a smart LCM of the present disclosure before activation; FIG. 10B shows a smart LCM of the present disclosure after activation.

FIG. 11 is an example of an effectively sealed slot disc by the smart LCMs of the present disclosure.

FIG. 12 is an example of an effectively sealed tapered disc by the smart LCMs of the present disclosure.

FIG. 13 illustrates the concentration of 2.5 mm particles needed to plug the fracture (top) vs. Concentration of 5 mm particles (bottom).

FIG. 14 illustrates the radius expansion of the smart LCMs.

FIG. 15 graphs the pressure buildup caused by the fracture seal.

FIG. 16 is a graphic representation of the stages of thermoset SMP programming

FIG. 17 is a simulation of particles inserted in the elliptical fracture.

FIG. 18 is a simulation of LCM particles expanding and sealing the fracture.

FIG. 19 graphs the pressure buildup on the smart LCM when the fracture is sealing.

FIG. 20 is a simulation of the concentration of LCMs needed to plug the fracture.

FIG. 21 is a simulation of stress release of the Smart LCMs.

FIG. 22 shows photographs of the smart LCM before activation (left) and after activation (right).

FIGS. 23A and 23B show an effectively sealed slot disc (23A) and tapered disc (23B) by the Smart LCMs.

FIG. 24 is a graphic representation of Cold-Programming for thermosetting SMPs (taken from G. Li, 2014).

FIG. 25 graphs measured stress of different types of SMPs pre-stressed at different values (taken from Li and Nettles, 2010).

FIG. 26 plots the change in volume of smart LCM versus pressure.

FIG. 27 is an example of a slot disc before it is sealed to represent the fracture in the formation.

FIG. 28A is an example of a 2000-micron width fracture slot and FIG. 28B is an example of a well-secured fracture slot in a core holder.

FIG. 29A is an example of a core holder with slot placed inside a mud cylindrical holder. FIG. 29B is an example of a rotating shaft, temperature sensor, and heating bath. FIG. 29C is an example of a complete set-up of the dynamic mud loss experiment.

FIG. 30 illustrates an example of a dynamic drilling fluid loss pattern at 120° F. with different mud formulations.

FIG. 31 provides the outer diameter (O.D.) and inner diameter (I.D.) of fracture core slot after the polymer/fiber blend dynamic fluid loss test at 120° F. Rings highlight the partially plugged fractures.

FIG. 32 is an example dynamic drilling fluid loss pattern at 212° F., with different mud formulations.

FIG. 33 provides a comparison of cumulative dynamic drilling fluid losses.

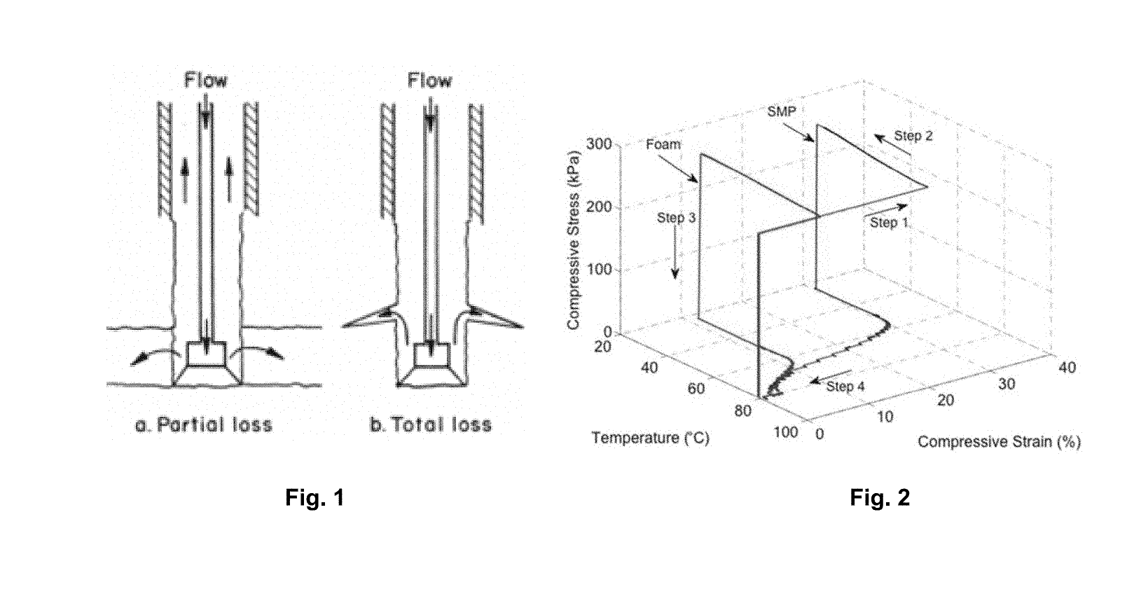

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of chemistry, material science, and the like, which are within the skill of the art. Such techniques are explained fully in the literature.

The following examples are put forth so as to provide those of ordinary skill in the art with a complete disclosure and description of how to perform the methods and use the structures disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, formation type, manufacturing processes, dimensions, frequency ranges, applications, mud type, specific temperature window or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DISCUSSION

Embodiments of the present disclosure provide for loss circulation materials, methods of making loss circulation materials, methods treating oil and gas well fractures using loss circulation materials, and the like. Embodiments of the present disclosure can be used in reducing the loss of drilling fluid (loss of circulation) in oil and gas wells during drilling. In particular, embodiments of the present disclosure can find use in oil and gas wells that have depleted reservoirs, natural and induced fractures, formations with very brittle and/or high porosity, and vugular formations.

Embodiments of the loss circulation material can include shape memory polymers either alone or in combination with other types of loss circulation materials (e.g., fibers, flakes, grains, nanoparticles, and the like). Embodiments of the shape memory polymers can be “programmed” through its chemical composition and its shape memory effect can be activated through phase transformation. In an embodiment, the shape memory polymers can be remotely controlled by in-situ heating without the need to interrupt the production process. Active control of the shape memory polymers provides engineers the ability to fill fractures to reduce loss of circulation of drilling fluids. In other words, filling the fractures with the loss circulation materials reduces the loss of drilling fluids to enhance oil and gas well production and profitability. Embodiments of the present disclosure are particularly advantageous, because unlike other loss-circulation materials, once activated the materials presently described maintain their expanded size regardless of temperature fluctuations in the fracture. Thus, the methods of the present disclosure provide for a permanent loss of porosity and increase in strength of the wellbore.

In an embodiment, the shape memory polymer (e.g., ionomer of ethylene acid copolymer, for example Surlyn® or specifically Surlyn® 8940) has a first state, a programed state, and an activated state. A more detailed description of the states and conversion of the states are provided below in reference to making the shape memory polymer and the Examples. In the first state, the shape memory polymer has a starting diameter. In the programed state, the shape memory polymer has a first diameter. In the activated state, the shape memory polymer has a second diameter. In an embodiment, the first state has a diameter greater than the programed state, while the programed state has a diameter that is less than that of the activated state. In an embodiment, the starting diameter can be about 100 μm to 1 mm. In an embodiment, the first diameter can be about 50 μm to 0.5 mm and the second diameter can be about 100 μm to 1 mm. In an embodiment, the shape memory polymer in the first state is about 10 to 60% larger than the shape memory polymer in the programed state. In an embodiment, the shape memory polymer in the activated state is about 10 to 60% larger than the shape memory polymer in the programed state.

If the shape memory polymer is not spherical in shape, one or more of the dimensions of the shape memory polymer (e.g., length, width) will increase in value upon conversion from the programed state to the activated state. Use of the term “diameter” throughout the disclosure is done for convenience and clarity, and one or more of the dimensions for non-spherical shape memory polymer can correspond to the diameter as used in the descriptions provided herein.

The shape memory polymer in the programed state will convert to the shape memory polymer in the activated state when a first temperature is applied to the shape memory polymer in the programed state. In an embodiment, the first temperature can be about 60 to 180° C., and is above the transition temperature of the polymer. The shape memory polymer in the programed state can be exposed to the first temperature in-situ in a fracture in an oil and gas well, and as a result a portion (e.g., about 50-99%, about 70-99%, about 80-99%, or about 90-99%) of the volume of the of the fracture is filled with the loss circulation material as the diameter of the shape memory polymer increases to that of the shape memory polymer in the activated state. In an embodiment, the process for disposing the loss circulation material in the fracture can take place over a time period (e.g., hours to days to weeks) to reach the desired level to reduce the loss of drilling fluid. In this regard, the shape memory polymer disposed at different times will be converted to the activated state at different times.

In an embodiment, the shape memory polymer can be a solid shape memory polymer in the form of a fiber. The fibrous shape memory polymer can be used alone or can be mixed with granular shape memory LCM or other loss circulation materials. In another embodiment, the shape memory polymer can be a solid shape memory polymer in the form of particulates. The particulate shape memory polymer can be mixed with other loss circulation materials. In an embodiment, granular shape memory polymers can be mixed with other commercial fibrous LCM products to achieve better results. In an embodiment, the shape memory polymer can be composed of a shape memory polymer or can have a coating layer of shape memory polymer around a core. In an embodiment, the shape memory polymer not including a core can have a diameter of about 20 μm to 1 mm or about 100 μm to 1 mm when the shape memory polymer is in the first state.

In an embodiment, the core can be a grain of sand, bauxite, ceramics, or other similar particle. In an embodiment, the core can have a diameter (or one or more of dimensions of a non-spherical shape memory polymer) of about 25 to 500 microns. In an embodiment, the layer of polymer can have a thickness of about 25 to 500 microns when the shape memory polymer is in the activated state. In an embodiment, the layer of polymer can have a thickness of about 25 to 500 microns when the shape memory polymer is in the programed state.

In an embodiment, the shape memory polymer can be surrounding some or all of a fiber. In an aspect, the fiber can reinforce the shape memory polymer. In an embodiment, the fiber can include metallic fiber (e.g., steel fiber, aluminum fiber, etc.), ceramic fiber (e.g., aluminum silicate fiber, silicon carbide fiber, etc.), polymeric fiber (e.g., polyethylene fiber, nylon fiber, etc.), mineral fiber (e.g., calcium inosilicate mineral fiber, magnesium aluminum phyllosilicate fiber), high performance synthetic fiber (e.g., carbon fiber, glass fiber, etc.), and the like. The fiber length can be about 100 μm to 10 mm with an aspect ratio (length to diameter) of about 50-100.

In an embodiment, the polymer should be a thermosetting shape memory polymer. In an embodiment, the thermosetting shape memory polymer can be selected for instance from organic thermosetting shape memory polymer in the epoxy family, the phenolic family, the polyester family, the polyimide family and a combination thereof.

In an embodiment, the loss circulation material can be included in a mixture including sand, bauxite, and/or ceramic other types of loss circulation materials, and/or other types of shape memory polymer, where different types can have different dimensions, made of different polymers, be made of a solid polymer material, be of a core/shell design, combinations thereof, and the like. In an embodiment, the other types of loss circulation materials can include fibers, flakes, granular materials, nanoparticles, swellable/hydratable materials, and combinations thereof. Additional loss circulation materials are disclosed in the Example.

In an embodiment, the shape memory polymer can be made by heating the shape memory polymer in the first state to a second temperature under a first pressure to form the shape memory polymer in the programed state. Subsequently, the shape memory polymer in the programed state is cooled under the first pressure to a third temperature, where the shape memory polymer remains in the programed state after cooling. The third temperature can be about the reservoir temperature.

In other words, the second temperature is greater than the transition temperature of the polymer, and since the molecular chains of the polymer are flexible, the polymer compresses under the first pressure. During the cooling process under the first pressure, the molecular chains of the polymer lock into place, so that when the first pressure is released, the shape memory polymer stays in the programed state. Heating the shape memory polymer in the programed state above the transition temperature of the polymer allows the locked molecular chains to release and convert to the activated state having a greater diameter.

In an embodiment, the loss circulation material can be used to fill fractures in oil and gas well. Once the loss circulation material is positioned in the fracture (e.g., the loss circulation material can be included in the drilling fluid or separately pumped into the well), the loss circulation material (e.g., the shape memory polymer) can be subject to a first temperature. The temperature can increase by injecting material having a higher temperature and/or through heating from the surrounding material. Upon exposure to the first temperature, the shape memory polymer in the programed state is converted to the shape memory polymer in the activated state, where the diameter of the shape memory polymer in the activated state has a diameter that is greater than the diameter of the shape memory polymer in the programed state. In this way, the shape memory polymer can be used to fill in fractures to reduce (e.g., about 20% or more, about 40% or more, about 60% or more, about 70% or more, about 80% or more, about 90% or more, about 95% or more, about 99% or more) loss of circulation of the drilling fluid or stop it completely. The shape memory polymer in the activated state does not change diameter upon temperature changes in the oil or gas well.

In various embodiments, the loss circulation material can be used to strengthen a wellbore. In an embodiment, the wellbore can be strengthened by disposing the loss circulation material into fractures in a well during drilling. Subsequently, the loss circulation material is exposed to the first temperature to converts the shape memory polymer in the programed state to the shape memory polymer in the activated state upon, wherein the expansion of the shape memory polymer fills a portion of the fracture. Expansion of the shape memory polymer strengthens the wellbore relative to the strength prior to expansion of the shape memory polymer. Subsequent change in the temperature of the oil and gas well to be different than the first temperature does not alter the activated state of the shape memory polymer, as long as the temperature is below the decomposition temperature of the polymer.

In an embodiment, the shape memory polymer can be degraded upon exposure to solvent (e.g. ionic liquid such as Trihexyl tetradecyl phosphonium chloride, organic solvent such as Dimethyl Sulfoxide, and the like). In this way, the fractures can be reversibly filled or strengthened. In an embodiment, the shape memory polymer can be degraded upon exposure to solvent (e.g. ionic liquid, organic solvent, and the like).

In an embodiment, the shape memory polymer can be programmed by a hydraulic pressure. The procedure is the same as the uniaxial compression programming as discussed above. This ensures expansion of the shape memory polymer in all dimensions when it is triggered for shape recovery.

While embodiments of the present disclosure are described in connection with the Example and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

In this disclosure, we disclose a new type of lost-circulation materials made out of shape memory polymers (SMP). Shape memory materials are a class of materials which can remember their permanent shape. These materials can be deformed into a temporary shape (so called programmed) and then retrieve the original shape via external environmental stimulus like heat, light or pH. Deformability and density of shape memory polymers utilized here (including epoxy, polystyrene, etc.) make them good candidates to provide hydraulic and mechanical isolation in the harsh environment in the subsurface. SMPs possess rubbery and glassy phases which are interchangeable through temperature changes; hence these materials would keep their programmability even after a number of loading and unloading sequences. This type of LCMs (e.g., ionomer of ethylene acid copolymer, for example Surlyn® or specifically Surlyn® 8940) would expand after placement (squeeze) inside the fractures. LCM expansion will seal the fracture and keep the fracture walls separated, which would increase the strength of the rock by adding some compressional circumferential stress around the wellbore, hence the wellbore after treatment can possibly sustain higher mudweight. In addition, the LCM will maintain its shape as the temperature of the well fluctuates.

TABLE 1
Nonproductive time due to lost circulation in deep-water wells

| | General populations: | 65 subsalt | 99 non-subsalt |
|---|---|---|---|
| Events related to wellbore | 263 wellbore < | wells: | wells |
| instability | 600 ft of water | WD > 3000 ft | WD > 3000 ft |
| Stuck pipe | 2.20% | 2.90% | 0.70% |
| Wellbore stability | 0.70% | 2.90% | 0.90% |
| Loss circulation | 2.30% | 2.40% | 2.00% |
| Kick | 1.20% | 1.90% | 0.80% |
| Total (%) of average drill days | 6.40% | 10.10% | 4.40% |
| Average days to drill | 35 | 97 | 54 |
| Total NPT* days | 4 | 29 | 9 |
| Total wellbore instability (days) | 2.24 days | 9.797 days | 2.376 days |
| Instability % of NPT days | 56.00% | 33.78% | 26.40% |
| Loss circulation days | 0.805 | 2.328 | 1.08 |
| Loss circulation % of NPT days | 20.13% | 8.03% | 12% |
| Average cost/ft | $758 | $3,360 | $2,492 |

### Lost Circulation Scenarios

During drilling process, drilling fluid is circulated back to the surface, and the fluid comes into contact with the wellbore. In traditional drilling practices, wellbore pressure exceeds that of the formation so that it will prevent the formation fluid from entering the wellbore. A filtration process takes place in the permeable rock, whereby the liquid component of the drilling fluid moves into the rock, leaving the solid particulates and emulsion droplets to collect the wellbore wall and form a filter cake. The low permeability of the filter cake makes very low volume of fluid lost by leak-off, and this is not considered as lost circulation.

Lost circulation is more likely to occur in the depleted reservoirs, natural and induced fractures, formations with high permeability and/or high porosity, and vugular formations. If the wellbore pressure is higher than the rock's tensile strength, fractures will form. Therefore, lost circulation is typically caused by a pressure imbalance and a pathway for fluid to enter the formation. Especially when drilling challenging wells, such as extended reach wells or deep water wells, the lower limit to the operational mud weigh window is increased due to higher collapse pressure in deviated well, while the upper limit, which is referred to the fracturing gradient, is reduced due to higher equivalent circulation density (ECD) in extended reach wells. This leads to a narrow operational mud weight window, which is more difficult to reach the predetermined depth and easier to cause lost circulation. There is no agreement on the guidelines or solution for a particulate loss volume. Ali Ghalambor (2014) summarized the lost circulation solution selection guidelines based on various loss severity and scenarios. An updated summary is given in Table 2.

TABLE 2
Lost Circulation Solution Selection guidelines

| | Typical Loss | Typical Formation | | |
|---|---|---|---|---|
| Classification | Rate | Characteristics | Preventative Solutions | Remedial Solutions |
| Seepage | Less than 1.6 m³/h | Sand | Particulate LCM | Particulate LCM |
| | [10 bph] | Sandstones | Managed Pressure | |
| | | Silt | Drilling | |
| | | | Drilling with Casing | |
| Partial | 1.6 to 16 m³/h | Unconsolidated sand or | Particulate LCM | Particulate/Fiber |
| | [10 to 100 bph] | gravel | Managed Pressure | LCM |
| | | Small natural fractures | Drilling | Cross-linkable |
| | | Small induced fractures | Drilling with Casing | LCM |
| | | | Solid Expandable | |
| | | | Systems | |
| Severe | More than 16 m³/h | Unconsolidated sand or | Managed Pressure | Particulate/Fiber |
| | [100 bph] | gravel | Drilling | LCM |
| | | Large natural fractures | Drilling with Casing | Cross-linkable |
| | | Large induced fractures | Solid Expandable | LCM |
| | | | Systems | |
| Total | No fluid return | Cavernous formations | Managed Pressure | Particulate/Fiber |
| | to the surface | Large, and/or numerous | Drilling | LCM |
| | | natural fractures | Drilling with Casing | Cross-linkable |
| | | Large, and/or numerous | Solid Expandable | LCM |
| | | induced fractures | Systems | |

### Current Technologies for LCMs

Popular lost circulation materials are waste products from the food processing or chemical manufacturing industry. The following Table 3 gives some common examples of LCMs by groups. In practice, it is very common to blend two or more groups of LCMs for prevention and remediation. Through the past few years, new solutions of LCMs emerged to meet the demand from the industries (see Table 3).

With the intense search for deep-water reservoirs, depleted reservoirs, reservoirs with wide fractures or pores, and reservoirs with extremely low pressures, conventional LCMs seem to not much likely to satisfy the operations to lost circulation control. In 1997, Amoco Canada Petroleum Co.'s started to apply a new lost circulation technology called SSPF (Shear-Sensitive Plugging Fluid) to seal the loss zones (Gregg Lindstrom et al., 1999). The Cranberry 10-19 well was the first Slave Point well drilled by Amoco without applying multiple cement plugs to cure Debolt losses. The SSPF treatment on the Cranberry 10-19 well resulted in only 12 hours of Nonproductive time (NPT), saving about $16,000 for a single well compared with conventional LCM treatments. During horizontal infill well drilling in the Pierce field in the UK Central North Sea (UKCNS), several lost circulation incidents occurred in Well B5 and Well C1 (David Murray et al. 2014). Different lost circulation treatments between these two wells brought extremely different economic effectiveness. The ECD window trend suggested that drilling into an existing weakened zone or fracture was the cause of the B5 losses at 2,066 ft. Prior to applying the right LCMs, the losses on B5 resulted in 10 days of NPT after 15 unsuccessful LCM attempts, using more than 51 t of LCM without any success. However, based on the curing of losses on B5, a new strategy for planning C1 was used. The first treatment was to prepare and pump Pill A with the result of 60 bb1/hr loss rate. Then a loss rate of 8 bbl/hr was established with HFHS-pill treatment within 2 days. These two cases tell us that developing new technologies on LCMs is still demanding to mitigate lost circulation for both prevention and remediation. In these years new lost circulation treatment technologies have been applied in the fields like nanoparticles technology (Hoelscher, K. P. et al., 2012), plug forming assurance technology (Wang. H et al., 2011), High Fluid Loss-High Strength Pills (Sanders, M. W. et al., 2010), and the migration of advances from “plugging a hole” to “borehole strengthening” (Darryl Fett et al., 2010). The following section will make an updated classification of LCMs based on appearances and applications.

TABLE 1.3
Classification of Lost Circulation Materials

| | Group | Examples | Notes |
|---|---|---|---|
| Conventional | Fiber | Raw cotton, cedar bark, shredded cane | Used in both WBM and OBM |
| | | stalks, hair, nylon fibers, bagasse, flax | |
| | | shive, bark fiber, textile fiber, mineral | |
| | | fiber, leather, glass fiber, peat moss, | |
| | | feathers, beet pulp, Magma fiber | |
| | Flake | Mica flakes, cellophane, cork, corn cobs, | Thin and flat in shape, very little |
| | | cottonseed hulls, vermiculite, flaked | stiffness |
| | | calcium carbonate | |
| | Granular | ground walnut shells, gilsonite, crushed | Higher crushing resistance, apply for |
| | | coal, perlite, coarse bentonite, ground | wellbore strengthening |
| | | plastic, asphalt, wood coke, ground | |
| | | thermoset rubber, thermoplastic | |
| | | particulates, calcium carbonate | |
| | LCM's | Ground marble, resilient graphite | Combinations of granular, fibrous, |
| | mixture | | flaky LCMs |
| Novel | Nanoparticles | silica nanoparticles, iron hydroxide, | apply to the small pore throat size in |
| | | calcium carbonate nanoparticles | shale formations |
| | High fluid | blend of different fibers | severe losses in fractured or highly |
| | loss, high | | permeable formations with aqueous |
| | strength | | mud, not for low permeability |
| | squeeze | | formations like shale, require special |
| | | | procedures to squeeze |
| | Acid/water | Calcium carbonate, mineral fiber, sized | Non-damaging the formation |
| | soluble | salts | |
| | Swellable/ | Blend of LCMs with reactive materials | Require special placement |
| | Hydratable | such as polymers | procedures, simultaneously pump |
| | LCMs | | one fluid down the drill string and |
| | combinations | | another through the annulus |

In general, 5 to 10 lb/bbl of RGC (Resilient Graphitic Carbon) plus 10 to 15 lb/bbl of SCC (Sized Calcium Carbonate) are used as a pretreatment. A total weight of 20 to 25 lb/bbl is desirable (Donald L. Whitfill et al., 2003). And later on, depending on the severity of the losses and potential risk, preventive sweeps can be added effectively with an amount of 50 lb/bbl. Prevention is critical, but, because lost circulation is such a common occurrence, effective methods of remediation are also high priorities. In conclusion, to make an effective lost circulation treatment, we need to obtain the knowledge of size, type, toughness of LCMs, and deep understanding in particle plugging or bridging mechanics near pores/fractures. Because lost circulation has always been a costly issue facing the industry, a focus on healing the loss zone quickly and safely encouraged the development of proprietary materials that conform to the fracture to seal off pores, regardless of changes in annular pressure. Hence, deformable, expanding LCM can be pumped ahead of cement jobs in zones that losses are expected. This type of material can have a comparatively high success rate for the prevention and remediation of severe losses.

### Shape Memory Polymers as LCM

Shape memory polymers (SMPs) are capable of storing a prescribed shape indefinitely and recover them by specific external trigger, e.g. heat. In the case of Shape Memory materials, the programming and shape recovery process are well described by the thermomechanical (TM) cycle, as shown in FIG. 2 for a pure amorphous SMP and SMP based syntactic foam. In general four steps are included in this cycle: (1) High temperature loading: the temperature is elevated to above the transition temperature, i.e. Tᵣ, where the mobility in the SMP molecular network is surged. The SMP molecular chains are flexible in this stage and they can cope with the applied external traction field. (2) Cooling: The SMP is cooled down to below Tᵣ while the external traction field is maintained. In this step the deformed molecular network retains the induced shape in step 1. (3) Low temperature unloading: The traction is then removed which result in elastically unloading the SMP and completing the programming process, and (4) Recovery: During the shape recovery stage the temperature is increased beyond the transition temperature where the locked molecular chains are able to restore their original configuration and in this step the SMP releases its memory. Considering the high temperature and pressure in oil and gas reservoirs, thermoset not thermoplastic SMPs should be used for this purpose. Programming should also be conducted at temperatures below the transition temperature such as cold compression programming for amorphous thermosetting SMPs (Li and Xu, 2010) or cold-drawing programming for semi-crystalline thermoplastic SMPs (Li and Shojaei, 2012). Theoretically, SMP recovers once the temperature enters the glass transition (T_{g}) region (usually, T_{g} is the center of this region). If recovery occurs at the lower temperature side of the T_{g} region, the recovery rate is low, but SMP particles will ultimately recover to the final shape at reasonable time scale before production drop in the wellbore. Additionally, LCM should be in the form of powder or particle. Hence, we need to first produce thermoset SMP in the form of particles in the lab and then show four stage of programming or cold-compression programming on the SMP particles in the lab conditions simulating underground conditions. We plan to examine different venues like spray, ball milling and collapsible porous casts to produce particulate SMPs.

SMPs are expected to be developed with epoxy, which is a thermosetting polymer with transition temperature higher than 150° C. and good mechanical strength and Young's modulus that makes it desirable for the application in hydraulic fracturing treatments.

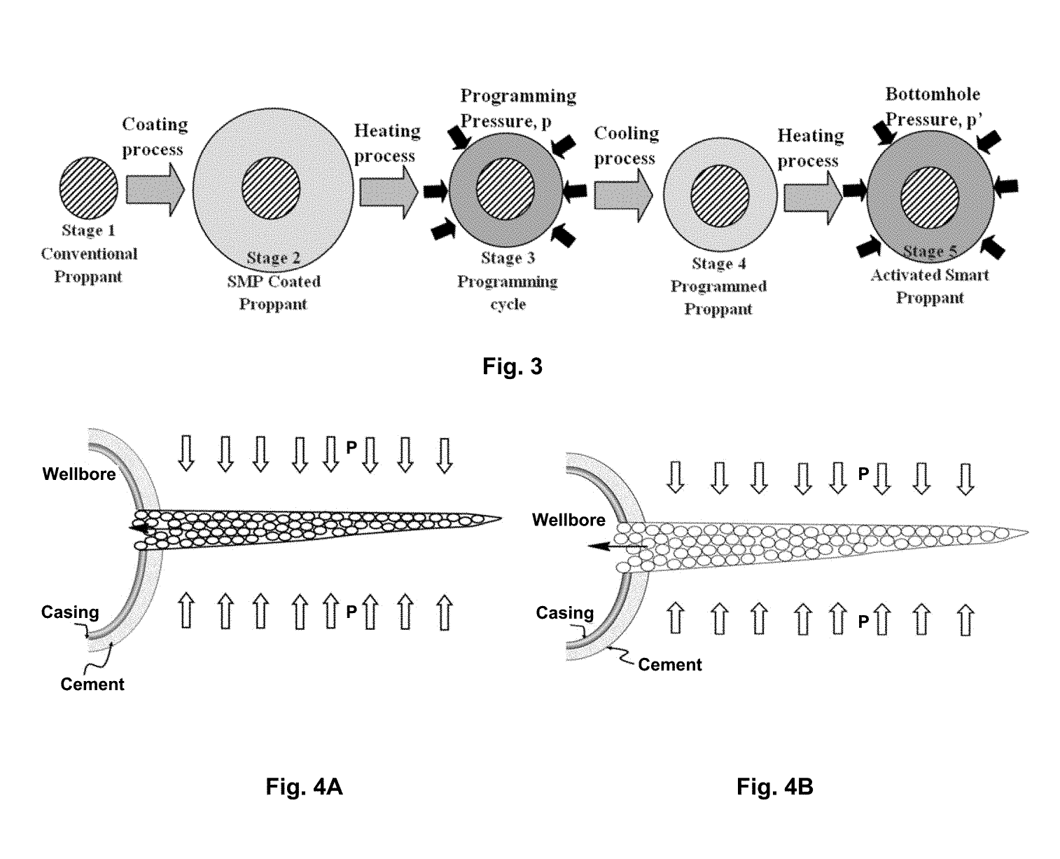

SMPs can be used as LCM in several forms. In the first form, SMP particles can be mixed with the regular LCMs and then is being pumped into the fracture. In the second case, only pure SMP particles will be used as LCM. In the third form, SMP can be coated onto other non-shape memory particles. The SMP coated particles can be programmed by hydraulic pressure, following a similar procedure to uniaxial programming. FIG. 3 demonstrates the manufacturing and programming process of SMP based LCM. The SMP coated particles should undergo programming cycle (stage 3 in FIG. 2) which is (a) heating process until T>T_{g}, (b) applying hydrostatic pressure P, (c) while maintaining the pressure the temperature is decreased to T<T_{g}. The programmed SMP (stage 4 in FIG. 3) in now ready to be deployed in fractured surfaces. Upon heating the programmed LCM, the SMP coating is activated and recovers its original shape. During the process of the shape recovery, released pressure will act on the fracture surfaces to close or seal the fracture. To investigate each approach, further experimental studies are required.

The smart LCM can be activated via heating by the surrounding rocks or electrical current or chemical agents. Upon activation, the SMP particle would release stress while their Young's modulus of elasticity decreases, hence the pore space between the particles placed inside the induced fracture would be filled by SMP deformations. Deformed SMP particles would provide hydraulic isolation between the fracture and well (FIG. 4). These expanding particles may also further increase the compressional circumferential stress around the wellbore or in other words, decrease closure stress artificially. LCM particles' flow-back would be also further restricted by their extension. SMP particles can be pumped through the MWD and the bit then drilled out shortly thereafter saving numerous trips in and out of the well.

Li et al. (2015) have introduced application of SMPs as sealant for filling the joints formed on the pavements, however, borehole condition require a SMP that can sustain an environment with much higher temperature and pressure.

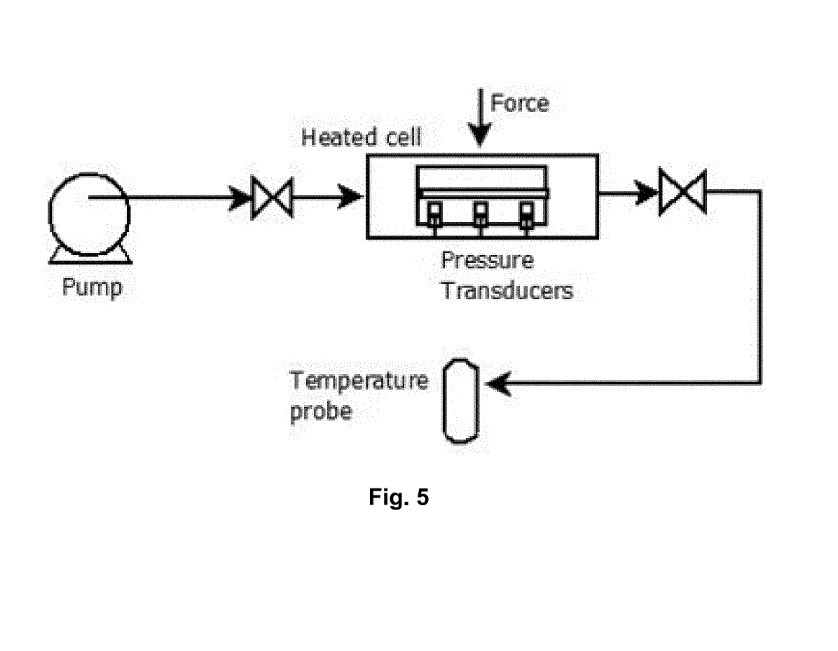

Preliminary experiments were carried out on an API conductivity cell to verify the functionality of LCM. The apparatus is originally designed to measure effectiveness of the LCM placed inside the fracture. Two sandstone cores were placed in parallel (simulating a fracture) inside the cell, filled with SMP and a hydraulic press was used to apply confining stress. Then, water is pumped at a constant flow rate through the cell so we can acquire pressure readings at the inlet and outlet of the cell, allowing us to calculate the permeability inflight. The experimental parameters are shown on Table 4 and the schematic of the apparatus is displayed in FIG. 5.

TABLE 1.4
Experimental conditions

| Parameter | Value | |
|---|---|---|
| LCM (SMP) particle size | 2 | mm |
| Flow rate | 10 | cm³/min |
| Confining stress | 5 | MPa |
| Initial temperature | 20° | C. |

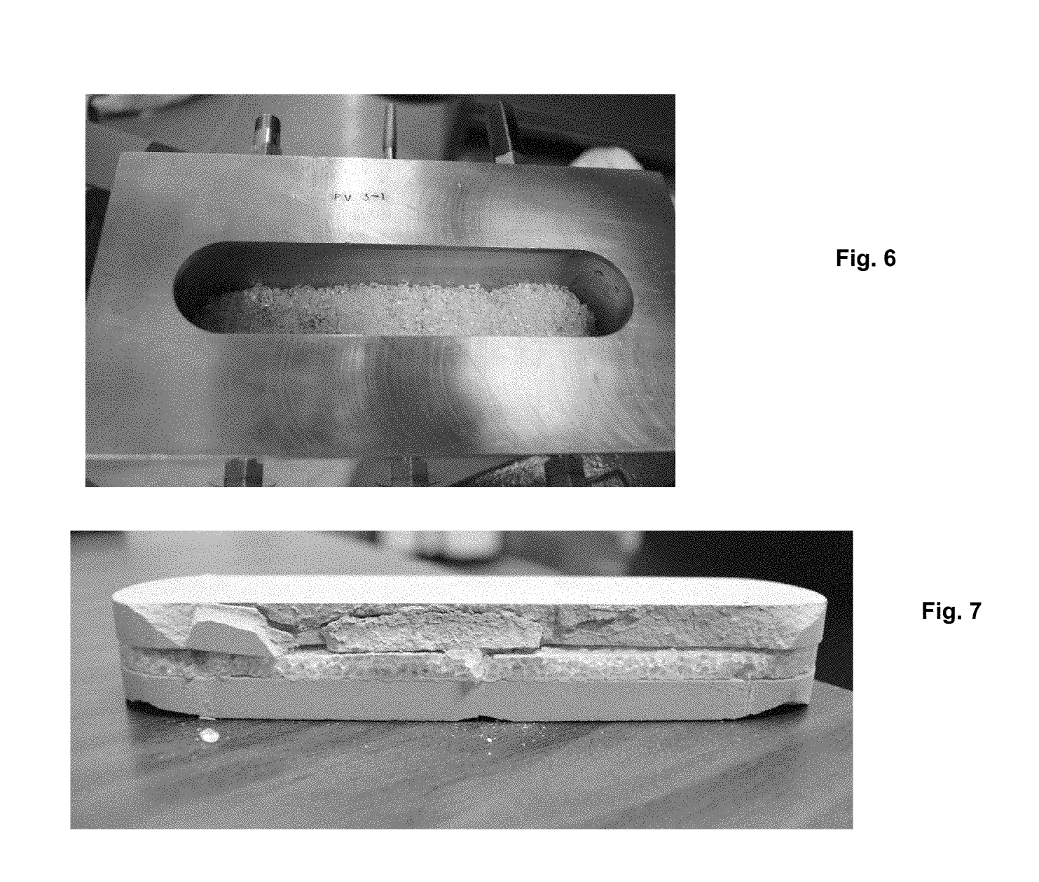

Initially, the LCM particles are not completely sealing the fracture due to the intergranular porosity. After wrapping the cell in a heating tape and heating the cell to 90° C., the SMP is activated and consequently permeability reduced significantly for at least 4 orders of magnitudes that can be measured in the lab. The permeability have not increased after cooling the sample. Therefore, we were able to verify functionality of this LCM upon expansion. Although initial LCM was a set of particles, the particles form an integrated wafer. FIG. 6 shows the particles before the expansion and FIG. 7 shows that the expansion of the SMP leaded to closure of the pores and consequently huge decrease in permeability. The decrease in permeability is confirmed by the high pressure readings acquired in the inlet of the cell. Therefore, the LCM effectively sealed the fracture after activation.

### Example 1 References

Ali Ghalambor, Saeed Salehi, Mojtaba P. Shahri, Moji Karimi, 2014. Integrated Workflow for Lost Circulation Prediction. SPE 168123, 2014.
Darryl Fett, Frederic Martin, Claude Dardeau, Joel Rignol, Saddok Benaissa, Jose Adachi, Jorge Pastor, 2010. Case History: Successful Wellbore Strengthening Approach in a Depleted and Highly Unconsolidated Sand in Deepwater Gulf of Mexico. SPE Drilling & Completion. Vol 25 (04), pp. 500-508.
David Murray, Mark W. Sanders, Kirsty Houston, Hamish Hogg, Graeme Wylie, 2014. Case Study-Equivalent-Circulating-Density Management Strategy Solves Lost-Circulation Issues on Complex Salt Diapirs/Paleocene Reservoir. SPE Drilling & Completion. Vol 29 (02), pp 194-207.
David Pritchard, Jesse Roye, Lillian M. Espinoza-Gala, 2012. Real-time data offers critical tool to redefine well control, safety. Drilling Contractor Magazine. Vol 68 (6), pp 96-109.
Donald L. Whitfill, Terry Hemphill, 2003. All Lost-Circulation Materials and Systems Are Not Created Equal. SPE 84319.
Gregg Lindstrom, Al Nord, Les Johnson, Patrick Murphy, and Philippe Revil, 1999. Shear-sensitive fluid cures Canadian lost circulation. Oil & Gas Journal. Sep. 27, 1999, pp 83.
Growcock F: “How to Stabilize and Strengthen the Wellbore During Drilling Operations,” SPE Distinguished Lecturer Program (2009/2010), http://www.spe.org/dl/docs/2010/FredGrowcock.pdf. (Accessed Feb. 17, 2015)
Hoelscher, K. P., De Stefano, G., Riley, M. and Young, S. “Application of Nanotechnology in Drilling Fluids”. SPE 157031, SPE International Oilfield Nanotechnology Conference and Exhibition, Noordwijk, Netherlands, 12-14 Jun. 2012.
Li, G. and D. Nettles, 2010, Thermomechanical characterization of a shape memory polymer based self-repairing syntactic foam. Polymer 51(3)755-762.
Li, G., Ji, G., and Meng, H., 2015, Shape Memory Polymer-Based Sealant for a Compression Sealed Joint. Journal of Materials in Civil Engineering 27(6)04014196.
Li, G., and Shojaei, A. 2012, A Viscoplastic Theory of Shape Memory Polymer Fibers with Application to Self-Healing Materials. Proceedings of the Royal Society A-Mathematical, Physical and Engineering Sciences 468(2144) 2319-2346.
Li, G., and Xu, W., 2011, Thermomechanical Behavior of Thermoset Shape Memory Polymer Programmed by Cold-Compression: Testing and Constitutive Modeling. Journal of the Mechanics and Physics of Solids 59(6)1231-1250.
Sanders, M. W., Scorsone, J. T., and Friedheim, J. E. “High Fluid Loss, High Strength Loss Circulation Treatments.” SPE 135472, SPE Deepwater Drilling and Completions Conference, Galveston, USA, 5-6 Oct. 2010.
Wang. Hong. “Is It Really Possible to Efficiently Form A Strong Seal inside Subterranean Openings without Knowing Their Shape and Size?” AADE-11-NTCE-25, AADE National Technical Conference and Exhibition, Houston, USA, 8-9 Apr. 2011.
Wang. Hong, Ronald Sweatman, Bob Engleman, Wolfgang Deeg, Don Whitfill, Mohamed Soliman, Brian F. Towler, 2008. Best Practice in Understanding and Managing Lost Circulation Challenges. SPE Drilling & Completion. Vol 23 (02), pp 168-175.

### Example 2

During drilling wells for oil and gas production, formation rock may fracture due to the temperature and pressure of the drilling mud inside the wells. Subsurface pre-existing fractures may also open under the pressure of the mudweight. Formation or opening of fractures and discontinues would lead to loose drilling fluid to the thief-zone which may have serious consequences like blowouts in addition to environmental hazards and economic costs due to the loss of drilling fluid to unwanted zones. In this disclosure, we present a new type of LCM which is basically a shape memory polymer that may expand after placement inside the fractures. LCM expansion will seal the fracture while it keeps the fracture walls separated which would strengthen the rock by adding some compressional circumferential stress around the wellbore, hence the wellbore after treatment can possibly sustain higher mudweight. The technology would safely reduce the loss circulation while drilling in fractured zone and save the rig operation time and costs by plugging induced fractures effectively.

According to Baker Hughes, LCM prices can range from $50 per 50 lb sack to $800 per 50 lb sack. However our proposed LCM production cost is about $200 per sack. Schlumberger also has the same range as Baker Hughes. While our proposed LCM is cheaper in comparison to other expandable LCM products available in the market, our proposed LCM doesn't involve any chemical reaction and is just an irreversible physical reaction which make it easier and reliable to use under different conditions.

Oil and gas companies are nowadays drilling through depleted formations as well as fractured reservoirs more than ever. While current Loss Circulation Materials (LCM) available in the market are only sealing the fractures, the proposed expandable LCM materials are not only sealing fractures more effectively but also the resultant release stress would increase the hoop stress around the well and strengthen the well by increasing mud weight and fracture gradient window.

The problem of lost circulation was apparent in the early history of the drilling industry. The industry spends millions of dollars a year to combat lost circulation and the detrimental effects it propagates, such as loss of rig time, stuck pipe, blow-outs and, frequently, the abandonment of expensive wells.

In recent years, the oil and gas industry is accelerating its drilling activities in deepwater and depleted zones, both of which present narrow operating limits in terms of the mud weight and fracture gradient window. Hence, it would be crucial to have an effective economic solution to address frequent mud loss and down time occurring in these weak formations. Although, current LCM products available in the market can seal drilling induced fractures, however, these seals may leak under higher pressure during drilling. Therefore, wellbore strengthening is another component that needs to be considered to have a safe and efficient field development program in fractured formations as well as depleted formations. Different independent studies have shown that 20-30% of drilling costs in these areas can be reduced by reducing the down time.

In this example, we disclose a new type of LCM as a disruptive product which is basically a shape memory polymer that may expand after placement inside the fractures. The smart LCM in this case is activated via formation temperature which makes application of these polymer based materials viable in high temperatures. The proposed LCM should not only sustain the high reservoir temperature (high glass transition temperature Tg) to avoid excessive large plastic deformation, but should also being triggered to release their stored stress slightly below the reservoir temperature to increase circumferential compressive stress and deform enough to fill the intergranular pore space. It is notable that the release stress should be large enough to open the crack to improve stress caging but not too large to crush the formation rock, hence we are looking for stress release ranging from 5-20 MPa, which is reachable with shape memory polymers.

The disclosed smart LCM can also effectively bridge at the fracture mouth and expand upon placement to stop lost circulation. The developed LCM not only seals the fracture but also provides some compressional circumferential stress like a stress cage around the wellbore to further strengthen the wellbore (competitive advantage). The developed smart LCM can be programmed through compression and has the ability to withstand high pressure and high temperature formations since its shape memory effect is activated through phase transformation by temperature. The final product saves the rig operation time and costs by plugging natural and drilling induced fractures effectively.

In terms of technology readiness level, a SMP polymer has been manufactured for the purpose of this project in our laboratory at LSU. The lab measurements proved the effectiveness of this polymer for LCM applications. The industrial scale production of the polymer is available; hence there should not be any challenge for production and application of this material in the field. Additionally, some polymers with shape memory properties are now produced and sold commercially for other purposes.

In this example, we propose manufacturing and testing a new type of loss circulation materials (LCM) (e.g., ionomer of ethylene acid copolymer, for example Surlyn® or specifically Surlyn® 8940) to stop severe mud loss through natural or induced fractures. The LCM is made from shape memory polymers that can expand after placement inside the fractures to fully seal the fractures. The described shape memory polymers can be manufactured in different sizes, shapes and properties based on the need and drilling environment condition like temperature. The produced SMP particle size distribution hence can be matched with distribution of openings in the rock to improve its sealing capability to be used in squeeze or sweep treatments. Expandable properties of these materials provide a mechanical approach for strengthening the wellbore by hoop stress enhancement. Shape memory polymers (SMPs) and Shape Memory Alloys (SMAs) are capable of storing a prescribed shape indefinitely and recover them by specific external trigger, e.g. heat. SMAs and SMPs have potential to be deployed in various engineering structures and devices. As compared to SMAs, SMPs have lower cost, higher recovery strain, and are more tunable.

In terms of economic perspective, it is notable that mud loss to the formation is one of the most costly and undesired encounters in the petroleum industry. It could be induced by drilling or could occur to the natural features of the reservoir itself. It causes a large amount of non-productive time that includes all services that support the drilling operation as well as the cost of the rig time. It was estimated that lost circulation alone accounted for US $2-$4 billion annual costs due to lost time. Not only non-productive time that lost circulation accounts for but also uncontrolled loss of fluid can damage the reservoir's formation and have a negative effect on its production potential and therefore, even more future losses. Operators involved in oil and gas operation in the Deepwater Gulf of Mexico and North Sea are the potential target market for LCMs. Loss circulation, stuck pipe, sloughing shales and wellbore collapse account for 44% of the total non-productive time.

The US Energy Information Administration website monitored the costs of drilling from 2002 to 2007. It was reported that the cost per well in 2002 for all wells was about $1 million and by the end of 2007 the cost per well was about 3.5 million dollars. This means that the cost increased more than triple the amount in just 5 years. The administration also reported the cost of drilling per foot for these 5 years and, in 2002, it was $187.46/ft.; the cost almost quadrupled in 2007 to $574.46/ft. This increase in the cost per foot was probably due to horizontal drilling, lost circulation problems due to fractured formations and other drilling-encountered problems. Halliburton has published a case study about a well in Wyoming. According to their study, the well experienced fluid loss of about 1033 barrels of oil-based fluid. This accounted for a total well cost of $380,000. Only 18 lb. of LCM per barrels of mud was needed to minimize the fluid loss. The LCM reduced the down-hole losses by 827 barrels and the fluid cost was reduced by about 400%. The drilling days were also reduced from 30 days to 26 saving four days of rig daily costs. Therefore, LCMs can be very effective to minimize costs when used correctly.

Naturally fractured reservoirs and carbonate oil and gas reservoirs are in general potential target markets for LCM as most of loss circulation incidents happens in these reservoirs. More than 80% of oil produced in the Middle East are coming from these carbonate reservoirs. Institute of American Drilling Contractors (IADC) estimates that average annual drilling cost in Middle East alone is $8 billion. Saving only 5%-10% of the rig time using more effective LCM materials can be interpreted to $400 to $800 million cost saving only in Middle East which means a lot in current oil price economic condition.

### Example 3

Lost circulation has been a problem since early days of rotary drilling. Drilling fluids is supposed to be circulated down to the bottomhole and come back to the surface for cutting transport and cooling the bit (White, 1956). However, when lost circulation occurs, drilling fluids are lost and loss circulation materials (LCMs) need to be added to the mud to stop further fluid loss. A lost-circulation incident may have a heavy financial and environmental cost that justifies the price of LCM products to treat the problem. Rig nonproductive time is another financial burden in these incidents (Whitfill and Hemphill, 2003). In addition, lost circulation leads to the mud levels falling, which can cause the well to be in an underbalance pressure state, and in severe cases, it may lead to a kick or even a blowout (Arshad et al., 2014). Lost circulation events usually occur in cavernous, karst, highly permeable and naturally fractured formations (Al-Saba et al, 2014). Since lost circulation is a very important issue, a lot of research has been conducted to minimize its impacts. Lost circulation materials are materials that seal the fractures and minimize mud loss. Nygaard et al. (2014) classified LCMs into seven categories being: fibrous, granular, flaky, acid/water soluble, mixture, high fluid loss LCM squeeze, swellable/hydratable LCM combinations and nanoparticles. Fibrous materials are a type of LCM that is slender, long and flexible and can be in different lengths and sizes of fiber. Fibrous materials may have a small degree of stiffness and when bridging a fracture, forms a mat-like bridge structure. Examples of fibrous materials would be cellulose fibers, mineral fibers and saw dust. Granular materials are “additives that are capable of forming a seal at the formation face or within the fracture to prevent the losses into the formation.” Granular materials are rigid with high crushing resistance and are often used for wellbore strengthening applications or preventive treatments. Examples of granular materials would be glisonite, course bentonite, perlite, asphalt and sized calcium carbonate. Flaky materials are a type of LCM that has a thin, flat shaper with a large surface area. They are not very stiff materials and form a bridge over the permeable formation face. Examples of flaky materials would be mica, cellophane, vermiculite, cottonseed hulls, corncobs and flaked calcium carbonate. Acid or water soluble LCMs are non-damaging LCMs since conventional LCMs could damage the formation when used in the reservoir section. Examples of acid soluble LCMs would be mineral fibers and calcium carbonate while water soluble LCMs would be a mixture of sized salts. Mixtures occur when two or more LCMs are combined together to yield a better performance in decreasing fluid loss. Swellable/Dehydratable LCMs are a blend of LCMs that contain a highly reactive material such as polymers. The highly reactive materials are activated by chemical reagents or when contacting drilling fluids. Nanoparticles are particles that could be added directly to the mud using an ex-situ procedure or could form from the addition of precursors that were added to the mud by the in-situ procedure. Examples of nanoparticles used in the field will be silica, calcium carbonate and iron hydroxide.

In the present disclosure, we demonstrate a new smart lost circulation material that not only seals the fracture but strengthens the wellbore. The smart LCM in this case is made out of shape memory polymers and is activated via the temperature of the bottomhole. It then can effectively seal the mouth or the tip of the fracture. The smart LCM can be programmed to be activated at a given formation temperature. Since the fracture needs to be sealed properly, our LCM was made out of thermoset polymers. The high temperature of the reservoirs softens the thermoset polymers a bit and allowing them to stick together and create a bridge that seals the fracture. The high stress released from these polymers ensures the sealing of the fracture mouth and according to the stress cage theory it provides compressional forces to strengthen the wellbore (Cook et al., 2012). It is notable that the release stress should not be very large to prevent the crack from further propagation. Therefore, the stress release for a bundle of thermoset smart LCM is set at 18 MPa. This value is reduced to 8 MPa when applied in the form of particulates.

The smart LCM that we disclose here was tested through lab experiments and numerical simulations. The experiment was performed using Permeability Plugging Apparatus with an LCM receiver. This apparatus is composed of a bed that represents the formation and fluid flows through this bed under a specific pressure to try and form a seal to prevent fluid loss. The beds can be slotted or tapered discs that stimulate either natural or induced fractures. The numerical simulations were made using LIGGGHTS, OpenFOAM and CFD-DEM coupling to ensure maximum sealing efficiency at wellbore conditions and to prove that our LCM provides compressional forces and strengthens the wellbore.

### Shape Memory Polymers

As mentioned above, our smart LCMs are made out of shape memory polymers (SMPs). Shape memory polymers are smart materials made out of polymers. The SMP has the ability to deform into a temporary shape and return back to its permanent shape when triggered by an external stimulus such as temperature change (Lendlein and Kelch, 2002). SMPs are capable of storing a prescribed shape indefinitely and recover them by a specific external trigger, e.g. temperature change. SMPs were used as smart cement additives to prevent cement shrinkage and failure in cement sheaths (Dahi Taleghani et al., 2016). SMPs were also used as smart proppants to increase the fracture's conductivity and permeability (Santos et al., 2016).

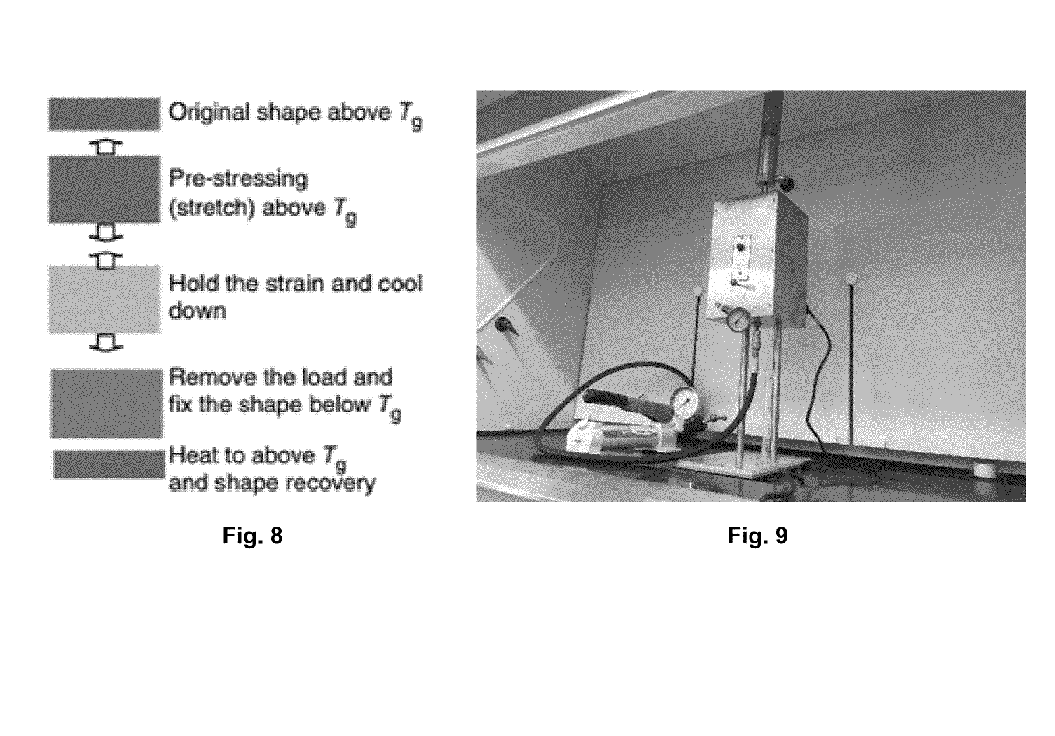

Thermoset polymers are in the form of foam or particles when acting as a lost circulation material. For thermoset polymers, the programming and shape recovery process are well described by the Thermomechanical cycle as seen in FIG. 8 for a pure amorphous SMP and SMP based syntactic foam.

In general four steps are included in this cycle: (1) High Temperature Loading: the temperature is elevated to become above T_{g}, i.e. T_{g}, where the mobility in the SMP molecular network is surged. T_{g} is glass transition temperature or glass deformation temperature. The SMP molecular chains in this stage are flexible and can cope with the applied external traction field, (2) Cooling: The SMP is cooled down to become below T_{g}, while the external traction field is maintained. In this step the deformed molecular network retains the induced shape in step 1, (3) Low Temperature Unloading: The traction is removed in this step and this results in the SMP being elastically unloaded and the programming process is completed now and (4) Recovery: In this step the shape is recovered by increasing the temperature to be above T_{g} where the locked molecular chains are able to restore their original configuration and the SMP releases its memory. The stress release in this recovery is higher than the stress release in thermoplastic polymers' recovery. Also, thermoset polymers should be very efficient when sealing fractures in HPHT formations since their material properties allow them to withstand high temperatures (Li, 2014). It is very important that we program our smart LCM since programming increases stiffness and the strength of the fibers. These properties are very important when the smart LCM is used to seal the fracture in the bottomhole. The recovery step for the Thermomechanical cycle represents post-programming. The programmed particles will enter the fracture and then recover. Since their shape will change, the particles will bridge and seal the fracture. The stress release from these particles will enhance the near wellbore stress and strengthen the wellbore.

### Economic Value of LCMs

In terms of economic perspective, it is notable that mud loss to the formation is one of the most costly and undesired encounters in the petroleum industry. It could be induced by drilling or could occur to the natural features of the reservoir itself. It causes a large amount of nonproductive time that includes all services that support the drilling operation as well as the cost of the rig time. Therefore, the industry has been developing new techniques in minimizing lost circulation, since a lost circulation incident costs more than the treatment.

It was estimated that lost circulation alone accounted for two to four US billion dollars annually due to lost time. It is not just non-productive time that lost circulation accounts for but uncontrolled loss of fluid can damage the reservoir's formation and have a negative effect on its production potential and therefore, even more future losses. (Cook et al., 2012). In the Gulf of Mexico, lost circulation, stuck pipe, sloughing shales and wellbore collapse account for 44% of the total non-productive time. The reason behind this is because they use synthetic-base muds that range from $100 to $200 per barrel and therefore, losing these fluids can be extremely costly. The more the non-productive time, the higher the cost.

According to Baker Hughes, LCM prices can range from $50 per 50 lb. sack to $800 per 50 lb. sack. Usually, the expensive LCMs are the plug types that are used as pills while the cheap LCMs are the ones that are continually added every time the mud is pumped into the bottomhole. With cases where the LCMs need to be added continuously to the mud, it is estimated according to Halliburton that between 15 lb. to 30 lb. of LCM per barrel of mud should be pumped on every stand. The US Energy Information Administration website monitored the costs of drilling from 2002 to 2007. It was reported that the cost per well in 2002 for all wells was about 1 million dollars and by the end of 2007 the cost per well was about 3 and a half million dollars. This means that the cost increased more than triple the amount in just 5 years. The administration also reported the cost of drilling per foot for these 5 years and in 2002 it was $187.46/ft. and almost quadrupled in 2007 to be $574.46/ft. This increase in the cost per foot was probably due to horizontal drilling, lost circulation problems due to fractured formations and other drilling-encountered problems.

The costs of most LCMs used today as seen above are very expensive and they also may not work properly in certain formations. The new smart LCM disclosed here is much cheaper than the LCMs used now and is almost equivalent to the price of resin which ranges from 0.01 $/lb to 0.9 $/lb. Having an effective LCM at this cost will save companies even more money especially when the oil prices were about 40 $/bbl in 2016.

### Unaddressed Issues and Disadvantages of Current LCMs

A lot of research and experiments have been done to make sure that LCMs can seal fractures effectively to minimize loss and non-productive time. However, LCMs still have disadvantages like limited application in high-pressure and high-temperature (HPHT) formations or causing damage to producing zones (Brandl et al., 2011). Some LCMs that are made out of polymers fail to deform and change back in shape once activated and this may be due to them dissolving the drilling fluid. Some LCMs especially the ones used in naturally fractured reservoirs work only for specific formations while fail in others. Therefore, it is important to find a material that can supplement a LCM or be used as an LCM without facing the problems mentioned above to save losses and non-productive time. Drilling engineers have reported clogging of drilling equipment from LCMs due to their large sizes. They used large sizes of LCMs because the small ones could not seal the fracture efficiently.

The smart LCM that we disclose has a lot of competitive advantages when compared to the LCMs used today in the field. Firstly, the smart LCM does not only seal the fracture but also provides some compressional circumferential stress like a stress cage around the wellbore to further strengthen the wellbore. Secondly, the developed smart LCM will be programmed through its chemical composition and has the ability to withstand HPHT formations since its shape memory effect is activated through phase transformation by temperature and pressure. Therefore, the smart LCM will be activated at a specific temperature based on knowing the temperature profile of the wellbore. This will therefore, lower the cost of producing different LCMs for different types of formations. Thirdly, the smart LCM here is able to work well with all types of muds and it does not fail to change shape while activated. Fourthly, the smart LCM has a volumetric change ability that would prevent the equipment used in the field from clogging and at the same time will ensure efficient sealing of the fracture. Finally, the smart LCM can be dissolved in solvent and therefore, will not cause any damage to production zones. The smart LCM is designed to work with all formations, especially naturally fractured carbonate reservoirs in the Middle East, and depleted zones in the United States such as the formations in the Gulf of Mexico.

### Experimental Method and Results

The objective of running this experiment was to create a field environment of lost circulation at a small scale to evaluate how effectively our smart expandable LCM would seal it. The equipment used to test the smart LCMs was the permeability plugging apparatus (PPA) shown in FIG. 9.

The particle plugging apparatus used is a high-pressure high-temperature instrument that has a maximum operating temperature of 500° Fahrenheit and a maximum operating pressure of 5000 psi. The PPA assembly consists of a hydraulic hand pump assembly to supply pressure, a 5000 psi stainless steel PPA cell where the fluid and LCM is placed, a PPA Heating Jacket to heat up the apparatus to specific temperatures, a dial thermometer to measure the temperature, a LCM PPA Receiver (without this receiver the PPA can become plugged creating difficulties in running the experiment), a backpressure receiver (used only if the temperature exceeds bubble point of the fluid), a carbon dioxide pressurizing assembly or nitrogen pressurizing assembly to work with the backpressure receiver, a graduated cylinder to measure the fluid loss and finally, slot discs and tapered discs to represent fractures.

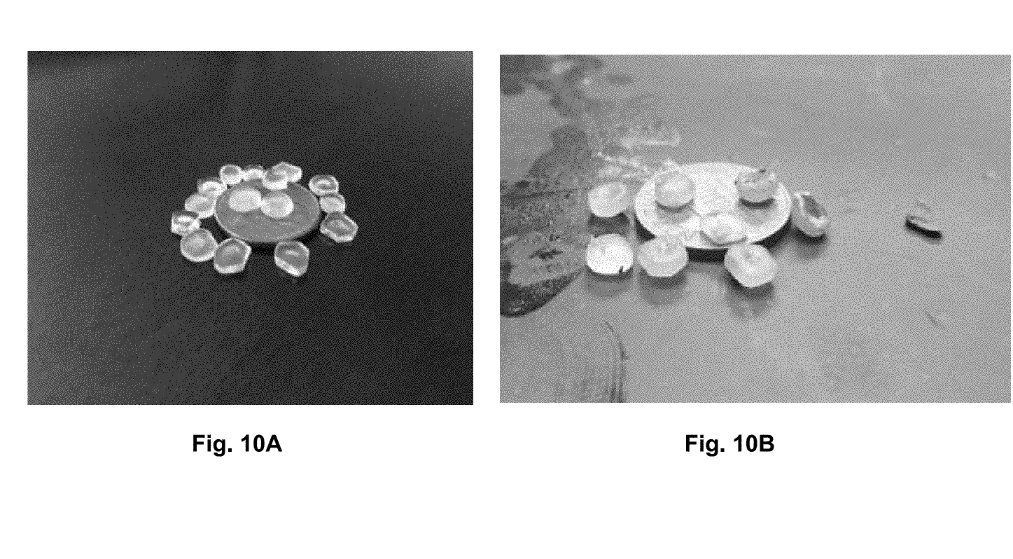

The smart LCMs as were in two diameter sizes, 2.5 mm and 5 mm. The smart LCMs activation temperature is 70° C. FIG. 10 shows the smart LCMs before and after activation.

The LCM receiver was filled with 170 ml of water-based mud mixed with a mixture of the sizes mentioned for the smart LCMs. One slotted disc and one tapered disc with descriptions described in Table 1, Example 3 were used to represent the fracture.

For each disc, the experiment was conducted at 3 temperatures of 60, 70 and 80° C. The fluid loss and the maximum pressure the seal can hold were recorded at each temperature. The fluid loss was measured by pumping hydraulic fluid in the cell until pressure started to build up. The fluid that came out before the pressure build up is the fluid loss. The maximum pressure build up is the maximum pressure the seal can hold before the seal is broken and fluid is lost again. Table 2, example 3 shows the results that were obtained from this experiment.

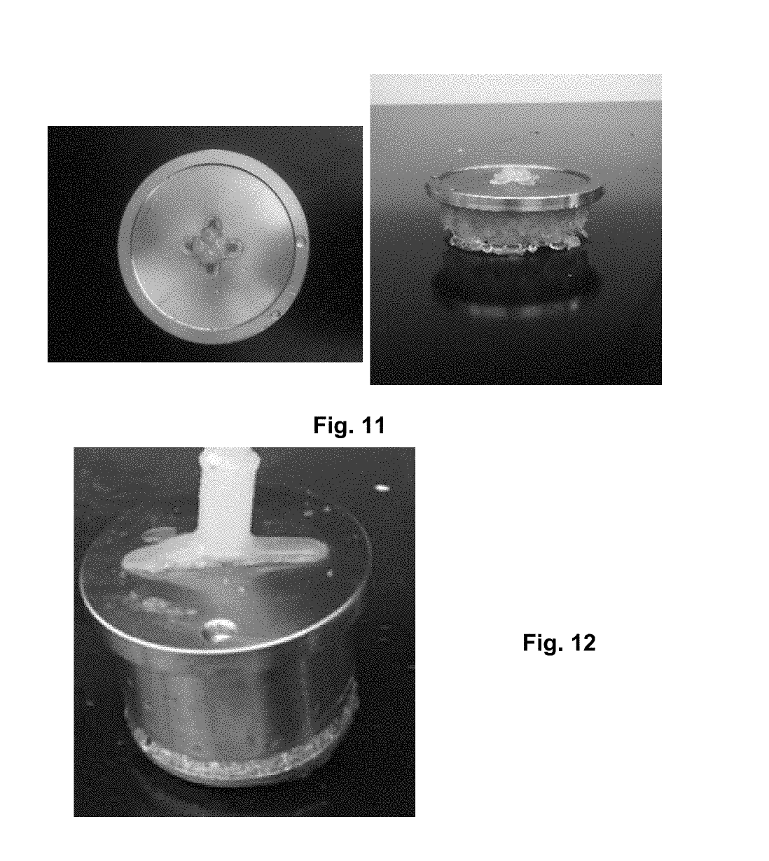

It can be seen from the results that when the smart LCM was activated, the fluid loss decreased significantly. By the time the PPA cell reached 80° C. all the smart LCMs were activated and the fracture was effectively sealed. The particles bridged together as seen in FIGS. 11 and 12 and were able to withstand extremely high pressures.

### Numerical Simulation Method and Results

The objective of the numerical simulation was to validate the pressure buildup caused by the smart LCMs in the experiment and to estimate the concentration of SMPs needed to successfully plug and seal a fracture. A fully coupled CFD-DEM simulation was made to measure the pressure buildup against time when the SMPs bridge and seal the fracture.

LIGGGHTS is an improved discrete element code for general granular and granular heat transfer simulations. By solving dynamics equation for particles, LIGGGHTS determines particle interactions, positions and velocities through discrete element method (DEM) in each time step. The main steps to complete a DEM simulation are listed as; first, “Initialization” and this is the step where defining of the initial configuration of the particles, boundary conditions and geometry are made. Second, “Application of Forces” and this is when forces such as gravity, friction caused due to neighbor particles, pressures etc. are calculated for each particle. Third, “Force Calculations” and this is when the velocity and acceleration of each particle is calculated based on the forces mentioned in step 2 using momentum balance. Fourth, “Integration” and this is when the position and velocity of each particle are calculated and updated according to a time step defined by the user. Fifth, “Analysis” and this is when the thermal and mechanical parameters are computed based on each time step. Each step from 1 to 4 is then repeated until the solution is solved and is complete. Finally, “Post Processing” and this is the part where is output data is processed to be graphically visualized.

OpenFOAM is a computational fluid dynamics (CFD) simulator. Computational fluid dynamics is the study of fluid flow, heat transfer and associated fluid phenomena through computer-based simulations. There are three steps needed to successfully complete a CFD simulation. First is “Pre-processing” and this is the part where the user needs to enter the input data. Input data could be grid size, geometry, fluid properties, etc. The physical and chemical phenomena are defined. Second is “Solving” and this part used finite volume method to evaluate partial differential equations in the form of algebraic equations. These equations are then solved using an iterative method. Each value is calculated based on a discrete place according to the mesh geometry. Finally, “Post Processing” and this part is where the solution can be graphically visualized.

Finally, the CFD-DEM coupling is can couple solid particle and fluid system simulations together. The particles' motions are modeled using the discrete element method approach and the fluid flow is modeled using the CFD approach previously described. Both of these approaches are coupled and a system of solid particles and fluids is formed were the conservation of momentum and mass is achieved (Zhu et al., 2007).

A fracture shape was built using SOLIDWORKS and imported to LIGGGHTS to test the smart LCMs. The fracture was of an elliptical shape with one side having radiuses of 40 mm and 12 mm and the other side has radiuses of 20 mm and 6 mm. The length between both sides was 30 cm. The particles in the simulation had the exact same properties as the Smart LCMs and they expanded by up to 25% of their original size when exposed to a temperature of 70° C. or above. The fluid used has a viscosity of 40 cp and a density of 10 ppg. The velocity that the mixture of fluid and particles were entering the fracture was 1.2 m/s. The time step used for this simulation was 0.00001 seconds and the simulation lasted 3 seconds. Pressure at the outlet was set to zero and the pressure at the inlet was set to 87 psi or 600 KPa.

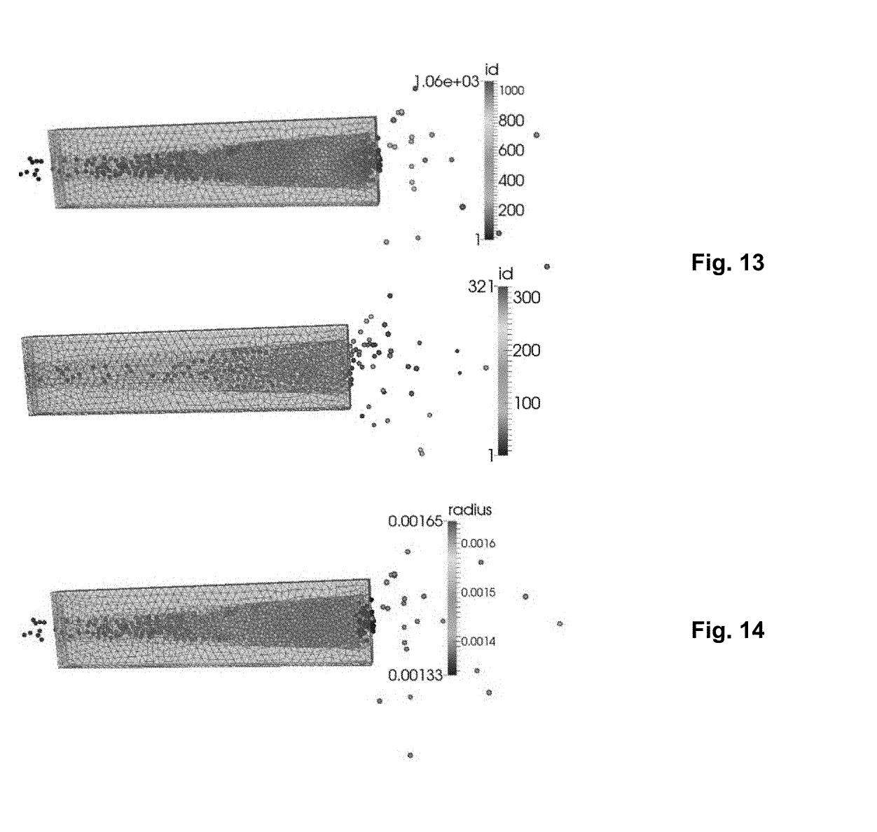

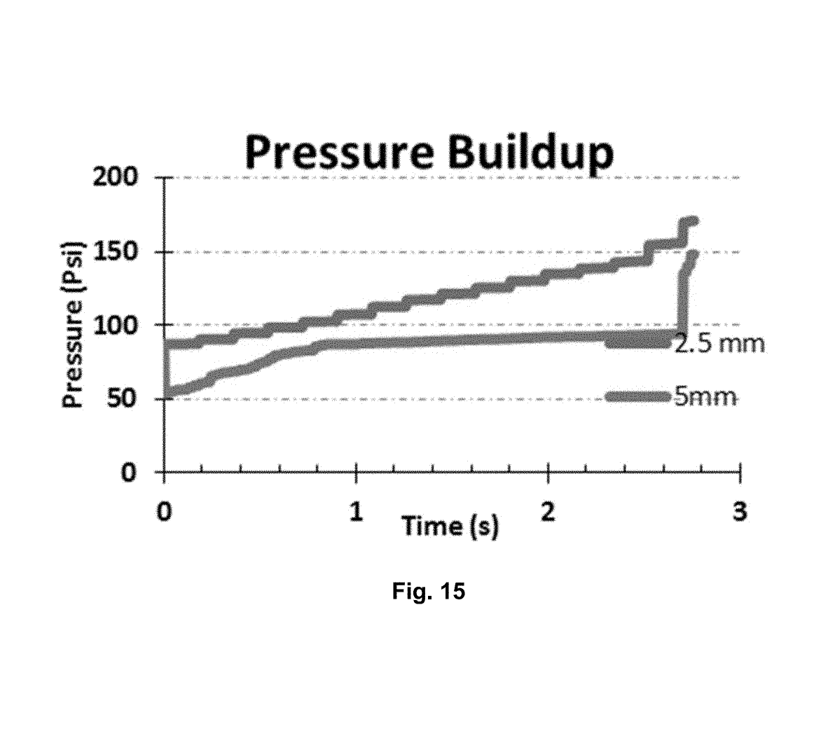

Two common particle sizes were selected to run simulations. The first particle size had a diameter of 2.5 mm and the second particle size had a diameter of 5 mm. For the first particle size, FIG. 13 shows the amount of particles needed to successfully plug the fracture. Since the particle sizes are very small compared to the fracture inlet size, the number of particles needed with a diameter of 2.5 mm to fully plug and seal the fracture is 1060 particles. The closer the particle size is to the smallest fracture inlet radius, the fewer particles will be able to clog the fracture. The number of 5 mm particles needed to plug the fracture are much less than the number of 2.5 mm particles. FIG. 14 shows the particle expansion when the fracture got plugged at the end of the simulation. As it can be seen, the closer the particle is to the end of the fracture the more it expands and this is because the particle has been heated for a longer time than the particles close to the fracture inlet and therefore have expanded more. However, expansion will never be more than 25% of the particles actual size. FIG. 15 shows the pressure build up for both the 2.5 mm and the 5 mm particles. It can be seen that the smaller particles sealed the fracture more efficiently than the bigger particles due to a larger pressure buildup. This could be explained due to the high concentration of particles filling up the fracture by the smaller particles and causing better packing than the bigger particles. The pressure for the bigger particle went down at first due to loss of fluid but then the pressure was built due to the fracture being plugged. However, for the smaller particles the pressure was building up as soon as it was applied due to a better sealing of the fracture because of the packing. This is why in the experiment both sizes were used to maximize the packing and decrease porosity.

### Conclusions

The smart expandable LCM shows promising results in sealing fractures efficiently and effectively by minimizing fluid loss. The LCM can be programmed for any wellbore temperature and any fracture size. Concentration and LCM size should be picked according to the size of the fracture and no damage to production zones will occur since the smart LCM can be dissolved in solvent.

### Example 3 References

1. Al-saba, M. T., R. Nygaard, A. Saasen, and O. M. Nes, 2014: “Lost Circulation Materials Capability of Sealing Wide Fractures,” Paper SPE 170285, presented in SPE Deepwater Drilling and Completions Conference, Society of Petroleum Engineers, Galveston, Tex., USA.
2. Arshad U, B. Jain, H. Pardawalla, N. Gupta and A. Meyer, 2014: “Engineered Fiber-Based Loss Circulation Control Pills to Successfully Combat Severe Loss Circulation Challenges During Drilling and Casing Cementing in Northern Pakistan,” Paper SPE 169343, presented at the SPE Latin American and Caribbean Petroleum Engineering Conference, Society of Petroleum Engineers, Maracaibo, Venezuela.
3. Brandl, A., Bray, W. S., Molaei, F., 2011: “Curing Lost Circulation Issues and Strengthening Weak Formations with a Sealing Fluid for Improved Zonal Isolation of Wellbores.” Presented in Australian Geothermal Energy Conference, Melbourne.
4. Cook J., F. Growcock, Q. Guo, M. Hodder and E. van Oort, 2012: “Stabilizing the Wellbore to Prevent Lost Circulation,” Oilfield Review 23, no. 4, 26-35.
5. Dahi Taleghani, A., Li, G., Moayeri, M., 2016: “The Use of Temperature-Triggered Polymers to Seal Cement Voids and Fractures in Wells,” Paper SPE 181384-MS presented in SPE Annual Technical Conference and Exhibition in Dubai, UAE.
6. Kloss, C., Goniva, C., 2011: “LIGGGHTS—open source discrete element simulations of granular materials based on Lammps,” Supplemental Proceedings: Materials Fabrication, Properties, Characterization, and Modeling, Volume 2, 781-788.
7. Lendlein, A., & Kelch, S. (2002): “Shape-memory polymers.” Angewandte Chemie International Edition, 41(12), 2034-2057.
8. Li, G. 2014: “Self-healing composites: shape memory polymer based structures.” John Wiley & Sons.
9. Nygaard, R., Alsaba, M. & Hareland, G., 2014: “Review of Lost Circulation Materials and Treatments with an Updated Classification.” Presented in AADE National Technical Conference and Exhibition, Houston, Tex., USA.
10. Santos, L., A. Dahi Taleghani, Li, G., 2016: “Smart Expandable Proppants to Achieve Sustainable Hydraulic Fracturing Treatments,” Paper SPE 181391-MS presented in SPE Annual Technical Conference & Exhibition in Dubai, UAE.
11. White, R. J., 1956: “Lost-circulation Materials and their Evaluation,” In Drilling and Production Practice. American Petroleum Institute.
12. Whitfill, D. L. and T. Hemphill, 2003: “All Lost-Circulation Materials and Systems Are Not Created Equal,” Paper SPE 84319, presented at the SPE Annual Technical Conference and Exhibition, Society of Petroleum Engineers, Denver, Colo., USA.
13. Zhu, H. P., Zhou, Z. Y., Yang, R. Y., & Yu, A. B., 2007: “Discrete particle simulation of particulate systems: theoretical developments.” Chemical Engineering Science, 62(13), 3378-3396.

### Example 4

One of the problems in rotary drilling is lost circulation. In order to transport cuttings and cool the bit, drilling fluids are supposed to be circulated down to the bottomhole and come back to the surface (White, 1956). When lost circulation occurs, drilling fluids are lost. To stop further fluid loss, loss circulation materials (LCMs) have to be added to the mud. This kind of incidents may have a heavy financial and environmental burden, which justifies the high price of LCM products. It would also increase the high cost of nonproductive rig time that is very valuable (Whitfill and Hemphill, 2003). The US Department of Energy reported in 2010 that on average 10% to 20% of the cost of drilling high-pressure, high temperature wells is spent on mud losses. Above all, lost circulation can lead to mud levels falling, which can cause an underbalance pressure state of the well. In severe cases, it may lead to a kick or even a blowout (Arshad et al., 2014). Instances of lost circulation usually occur in cavernous, karst, highly permeable and naturally fractured formations (Al-Saba et al., 2014). If lost-circulation zones are anticipated, preventive measures should be taken by treating the mud with loss of circulation materials (LCMs) and preventive tests such as the formation integrity test should be performed to better define the mudweight window to limit the possibility of loss of circulation. Hence, lost circulation is a very important issue which has led to a lot research dedicated to minimize its negative impacts and the biggest breakthrough has been LCMs. They are designed to seal fractures and minimize mud loss. The seven categories of LCMs classified by Nygaard et al. (2014) are: fibrous, granular, flaky, acid/water soluble, mixture, high fluid loss LCM squeeze, swellable/hydratable LCM combinations and nanoparticles. Each material varies in its chemical properties, flexibility, shape and the way they seal the fracture.

In this example we describe a new smart lost circulation material that not only seals the fracture but strengthens the wellbore. The smart LCM in this case is made out of shape memory polymers and is activated by exposure to downhole temperature. The smart LCM will be mainly focused on shielding the tip of the fracture and sealing it from the tip all the way to the mouth. In other words, it will not only act as a lost circulation material but also as a wellbore strengthening material. The smart LCM can be programmed to be activated at any given formation temperature. Since the fracture needs to be sealed properly, the LCM presented here is made out of thermoset polymers. The high temperature of the reservoirs does not soften the thermoset polymers to flow and allows them to stick together. The cohesive (sticking) property of this LCM helps it create a bridge that seals the fracture. The high stress released from expansion of these polymers ensures the sealing of the fracture tip and mouth and providing compressional forces to strengthen the wellbore (Cook et al., 2012). It is notable that the release stress should not be very large damage/crush the rock or cause uncontrolled fracture propagation. Therefore, the stress release for a bundle of thermoset smart LCM is set at 18 MPa. This value is reduced to 8 MPa when SMP is utilized in the form of particulates.

The smart LCM that we describe here was tested through lab experiments and numerical simulations. The experiment was performed using Permeability Plugging Apparatus with an LCM receiver. This apparatus is composed of a bed that represents the formation and fluid flows through this bed under a specific pressure to try and form a seal to prevent fluid loss. The numerical simulations were made using LIGGGHTS, OpenFOAM and CFD-DEM coupling to ensure maximum sealing efficiency at the bottomhole conditions and to prove that our LCM provides compressional forces and strengthens the wellbore.

### Shape Memory Polymers

As mentioned above, our smart LCMs are made out of shape memory polymers (SMPs). The SMP has the ability to deform into a temporary shape and return back to its permanent shape when triggered by an external stimulus such as temperature change or electromagnetic waves (Lendlein and Kelch, 2002).

Thermoset polymers behave differently when exposed to different temperatures. When these polymers get heated to the glass transition temperature (T_{g}), the molecules become more mobile and there are higher possibilities of having the segments move along the loading direction. This is the volumetric change property that the smart LCM has and this property can be explained by the free volume theory. The free volume theory states that temperature has no effect on the occupied volume however, the interstitial free volume can linearly change with temperature. On the other hand, the whole free volume nonlinearly changes with temperature. Mixing curing agent and liquid resin together is the major two parts in thermosetting polymers.

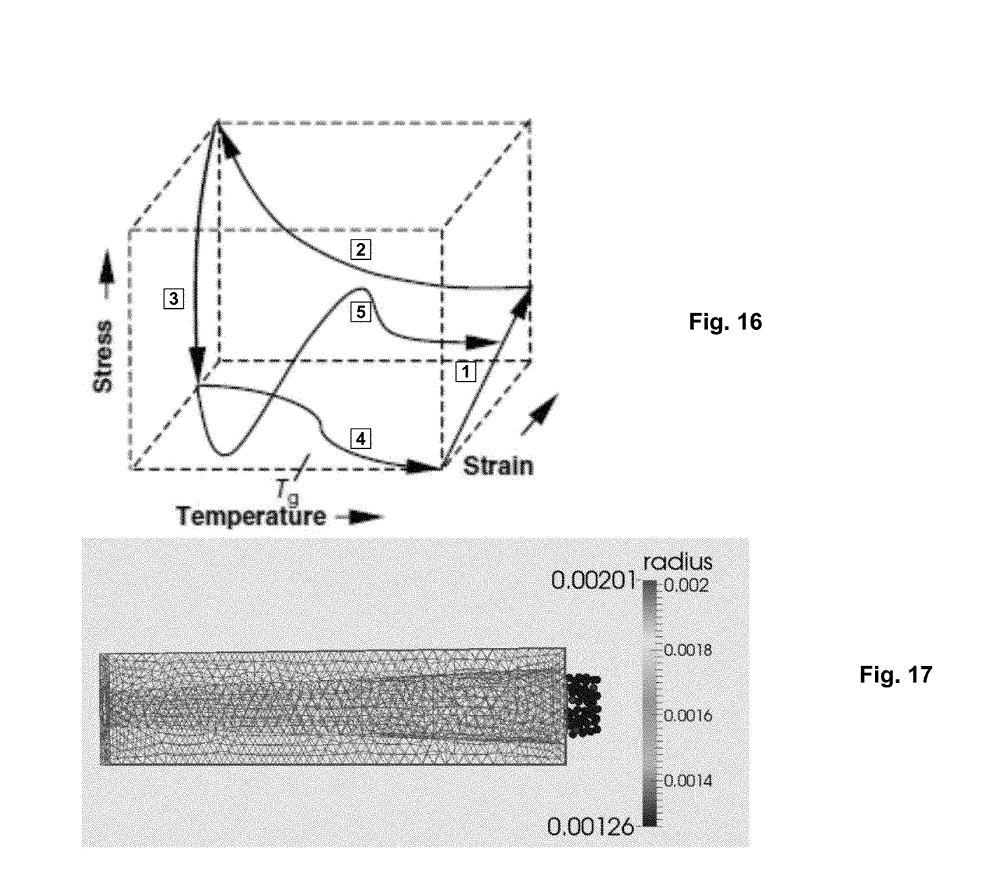

The French Company CDF Chimie Company was one of the first companies to develop shape memory polymers. They created polynorbornene based SMP in 1984 (Xie, 2011). However, it has never been used in the petroleum industry until recently due to the new innovative ideas that have been needed to address field challenges. Some of the examples where SMPs were used in the field would be using them as smart cement additives to minimize failure in cement sheaths and prevent cement shrinkage (Dahi Taleghani et al., 2016). They have also been used as in-situ expandable proppants to increase the fracture's permeability and conductivity (Santos et al., 2016). With respect to the micro-Brownian thermal motion, the conformational entropy of the molecular segments is the main reason why shape recovery occurs. The molecular mobility changes and the viscosity is reduced when the temperature increases above T_{g}. These changes cause the molecules to reel off to their original shape configuration. In a macroscopic manner, the thermoset polymer will recover back to its original shape. This process is autonomous due to the increase in entropy (Li, 2014). In order for the shape memory polymers to change into a memorized shape and be able to return to its original shape, a process called programming needs to be made. A full thermomechanical (TM) cycle consists of three-step programming and one-step recovery. This TM cycle includes changes in stress, temperature and strain. The four steps as seen in FIG. 16 are as follows: (1) High Temperature Loading: the temperature is elevated to above T_{g}, i.e., glass transition temperature, where the mobility in the SMP molecular network is surged. The SMP molecular chains in this stage are flexible and can cope with the applied external traction field, (2) Cooling: The SMP is cooled down to below T_{g}, while the external traction field is maintained. In this step the deformed molecular network retains the induced shape in step 1, (3) Low Temperature Unloading: The traction is removed in this step and this results in the SMP being elastically unloaded and the programming process is completed now, and (4) Recovery: In this step the shape is recovered by increasing the temperature to above T_{g} where the locked molecular chains are able to restore their original configuration and the SMP releases its memory.

When the three-step programming is made, the smart LCM is ready to be used in the field. The programmed particles will enter the fracture and then recover its original shape when exposed to a high enough temperature i.e. the bottomhole temperature in this case. This shape recovery is an expansion and the particles will release stress that will strengthen the wellbore.

### Unaddressed Issues and Current Disadvantages of Commercial LCMS

To make sure that LCMs can seal fractures effectively and minimize loss and non-productive time, a lot of research has been dedicated toward this matter. Some disadvantages that have been discovered about LCMs are their limited application in high-pressure and high-temperature (HPHT) formations and damage to producing zones (Brandl et al., 2011). In some instances, LCMs that are made out of polymers have failed to deform and change back in shape once activated. This failure to change back in shape may be due to their property of dissolving in the drilling fluid. Some LCMs, especially the ones used in naturally fractured reservoirs, work only for specific formations while fail in others. There are reports by drilling engineers that have faced clogging of drilling equipment from LCMs due to their large sizes. They used the large sizes of LCMs because the small ones could not seal the fracture efficiently. Due to such a risk of adverse effects, it calls into question if there is such a material that can supplement a LCM, or be used as a LCM, without facing these disadvantages.

The smart LCM that we disclose has a considerable measure of advantages when contrasted with the LCMs utilized as a part of the field today. Firstly, the smart LCM seals the crack as well as gives some compressional circumferential stress that acts like a stress confine around the wellbore to additionally fortify the wellbore. Also, the created smart LCM will be modified through its chemical composition and can withstand HPHT arrangements since its shape memory impact is actuated through phase change by temperature. Hence, the smart LCM will be enacted at a particular temperature in view of knowing the temperature profile of the wellbore. This would bring down the cost of delivering diverse LCMs for various uses. Thirdly, the smart LCM here will have the capacity to function efficiently with a wide range of muds and it won't neglect to change shape while enacted. Fourth, the smart LCMs has a volumetric change property that would keep the hardware utilized and also keep it from obstructing and in the meantime will guarantee proficient sealing of the crack. At long last, the smart LCM will not be in the form of liquid when inserted in the bottomhole and therefore, the rocks' permeability will not be damaged since the pores will not be invaded and in this manner, won't bring any harm to production zones. The smart LCM should work with all formations, particularly naturally fractured carbonate reservoirs in the Middle East, and drained zones in the Unified States, for example, the formations in the Gulf of Mexico.

### Wellbore Strengthening

As mentioned above, the smart LCM will also be acting as a material that strengthens the wellbore. Wellbore strengthening is a set of techniques that could increase the fracture gradient by effectively sealing and plugging fractures using LCMs. (Salehi and Nygaard, 2012).

Fuh et al. (1992) tested LCMs performance using theoretical approaches and field trials. They created a fracture pressure inhibitor model. This model suggested that LCMs screen out at the fracture tip, form a seal and decrease fracture propagation pressures and formation breakdown. Van Oort et al. (2011) introduced the fracture propagation resistance model using the DEA-13 experiments presented by Morita et al. (1990). The model also suggests that when the fracture tip is isolated and sealed by the LCM, the fracture propagation pressure increases, therefore the fracture gradient is enhanced. Dupriest (2005) introduced the fracture closure stress model. This model describes the stress on the fracture plane that keeps the fracture faces in contact. Increasing the fracture width and sealing the fracture tip could increase this stress. When the fracture tip is sealed, adjacent rocks are compressed and near wellbore hoop stresses change. Therefore, a lot of theories have focused more on fracture tip sealing. However, Alberty and Mclean (2004) presented a stress cage model using linear elastic fracture mechanics model. The model explains that the hoop stress around the wellbore is enhanced and increased when LCMs seal the fracture mouth. Salehi (2012) tested the wellbore hoop stress enhancement theory using a 3D poroelastic, finite element model. This model simulated fracture initiation, propagation and sealing the fracture mouth. Simulation results showed that if the fracture mouth is effectively sealed, the hoop stress around the wellbore would be increased and restored. Therefore, researchers have come up with theories to see which out of the fracture mouth or tip if sealed will be the most effective. Our LCM's compressive stress release due to its expansion causes the fracture to further propagate and allow the LCMs to reach and seal the tip of the fracture. Our LCMs could also be activated at the fracture mouth and therefore seal it. In both cases the compressive stress release increases the fracture's minimum horizontal stress and therefore, strengthens the whole wellbore.

### Numerical Simulation

The first objective of the numerical simulation is to measure the pressure buildup caused after utilizing the smart LCMs and compare it to the pressure buildup results derived from the experiments. The fracture sizes in the experiment and the numerical simulations are different and therefore relating the concentration needed to the size of the fracture would be the second objective. Finally, measure the stress release of a bundle of LCMs in porous media. A fully coupled CFD-DEM simulation is made to measure all of the above.

The main steps to complete a DEM simulation are listed as first, “Initialization” and this is the step defining the initial configuration of the particles, boundary conditions and geometry. Second, “Application of Forces” and this is when forces such as gravity, friction caused due to neighbor particles, pressures etc. are calculated for each particle. Third, “Force Calculations” and this is when the velocity and acceleration of each particle is calculated based on the forces mentioned in step 2 using momentum balance. Fourth, “Integration” and this is when the position and velocity of each particle are calculated and updated according to a time step defined by the user. Fifth, “Analysis” and this is when the thermal and mechanical parameters are computed based on each time step. Each step from 1 to 4 is then repeated until the solution is solved and is complete.

OpenFOAM is a computational fluid dynamics (CFD) simulator. Computational fluid dynamics is the study of fluid flow, heat transfer and associated fluid phenomena through computer-based simulations. There are three steps needed to successfully complete a CFD simulation. First is “Pre-processing” and this is the part where the user needs to enter the input data. Input data could be grid size, geometry, fluid properties, etc. The physical and chemical phenomena are defined. Second is “Solving” and this part used finite volume method to evaluate partial differential equations in the form of algebraic equations. These equations are then solved using an iterative method. Each value is calculated based on a discrete space according to the mesh geometry.

Finally, the CFD-DEM coupling can couple solid particle and fluid system simulations together. The particles' motions are modeled using the discrete element method and the fluid flow is modeled using the CFD approach previously described. Both of these approaches are coupled and a system of solid particles and fluids is formed where the conservation of momentum and mass is achieved (Zhu et al., 2007). In this work two different types of simulations were made. The first simulation was made for the pressure buildup and calculating the LCM concentration for sealing efficiency while the second one was made for calculating the compressive stress of the LCMs.

For the first simulation, the fracture shape grid was built using SOLIDWORKS and imported to LIGGGHTS and OpenFOAM to test the pressure buildup and concentration of LCMs when the fracture is sealed. The shape consisted of a box that represented surrounding rocks with an elliptical hole of 35 cm in length that represented the fracture. The side of the elliptical fracture where the LCM particles and drilling fluid were inserted had diameter sizes of 22.5 mm and 7 mm. The side where the LCM particles and drilling fluid exited had diameter sizes of 12 mm and 4 mm. The LCM particles in LIGGGHTS that were inserted in the fractures had diameter sizes of 2.5 mm and 4 mm as seen in FIG. 17. Both of these different sized particles were mixed and inserted together and the concentration of the 2.5 mm particles is three times the concentration of the 4 mm particles. The reason behind this is fill as much space of the fracture as possible according to bridging theories. The particles were allowed to expand by up to 30% of their size when exposed to the activation temperature. How much expansion the particles made was based on how much the particles have travelled down the fracture. The particles had a density of 950 kg/m³, Young's Modulus of 260 MPa and a Poisson's ratio of 0.4. For OpenFOAM, the fluid had a density of 1300 kg/m³ and a plastic viscosity of 0.035 Pa·s. For the CFD-DEM, the fluid and particles were mixed together before entering the fracture. At the inlet of the fracture, a constant pressure of 455 kPa (66 psi) was applied and at the end of the fracture a constant pressure of 0 Pa. The temperatures were set to 75 Degrees Celsius and 85 Degrees Celsius at the inlet and the outlet of the fracture respectively. Fluid and particles entered the fracture at a speed of 1.2 m/s and then the velocity was recalculated according to the pressure being applied and the pressure buildup occurring due to the sealing of the fracture. The whole simulation was allowed to run for 8 seconds at a time step of 0.000001 step/second.

The second simulation was mainly a DEM simulation. The fracture shape was also built using SOLIDWORKS and imported to LIGGGHTS. OpenFOAM and CFD-DEM Coupling were not used for this simulation. The main objective of this simulation was to measure the stress release the LCMs do. The fracture shape was exactly the same as the first simulation. However, the particles had diameter sizes of 2.5 mm and 5 mm. The particles were also mixed together and inserted at a concentration of the 2.5 mm particles being three times more than the concentration of the 5 mm particles. The total number of particles inserted was 450. The temperature all throughout the fracture was set to 75 Degrees Celsius and the particles were allowed to expand by up to 30% of their size when exposed to the activation temperature. The particles entered the fracture at a speed of 1 m/s. The particles had the exact same properties as the ones they had in the first simulation and the simulation was run for 10 seconds at a time step of 0.000001 step/second.

### Numerical Results and Discussions

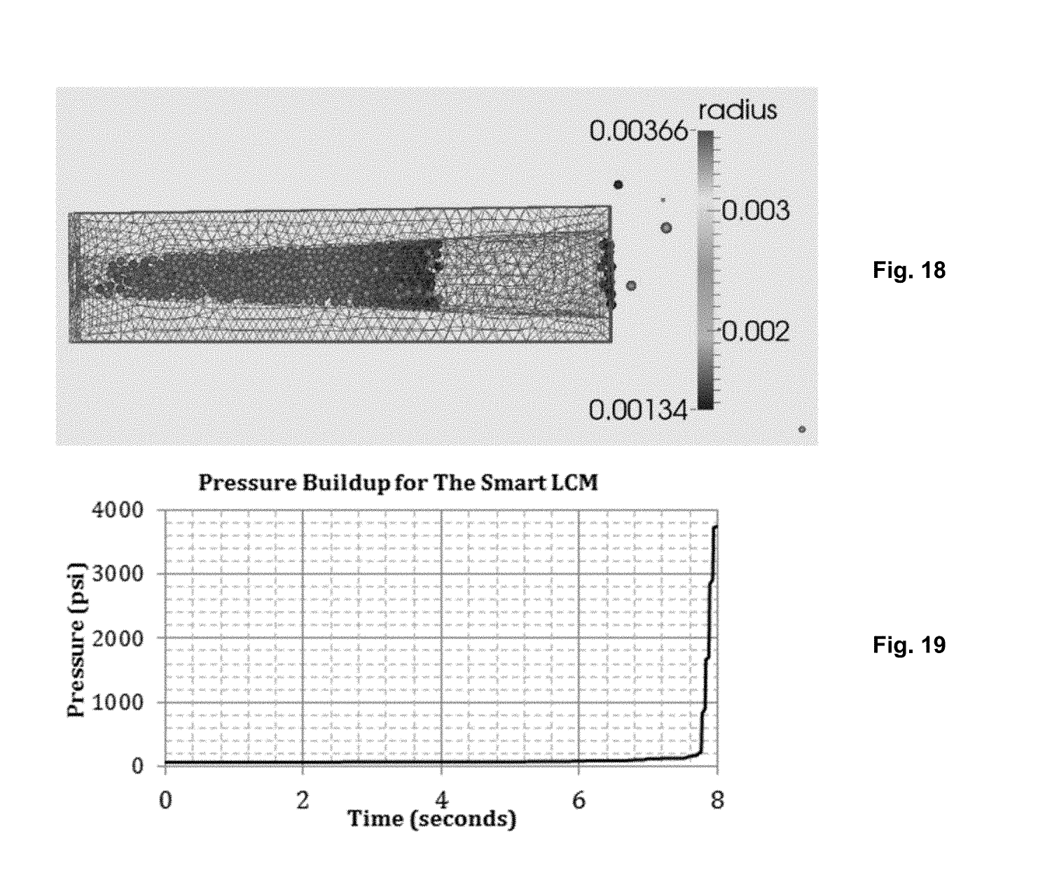

When the drilling fluid and particles entered the fracture, they were exposed to high temperature and high pressure. The particles as seen in FIG. 18 started to expand and reach the tip of the fracture. The particles expanded to where they stayed in place and sealed the tip of the fracture. As more particles were inserted, they started to move towards the mouth of the fracture and prevent the fluid from escaping.

As the particles started to fill the fracture and the fluid was not able to escape, the pressure applied on the mixture started to build up as seen in FIG. 19. The pressure reached 25 MPa (3743 psi) in 8 seconds due to this effective sealing. It can be seen that at the first 6 seconds, the particles were still sealing the fracture, but after that, the pressure buildup was instantaneous.

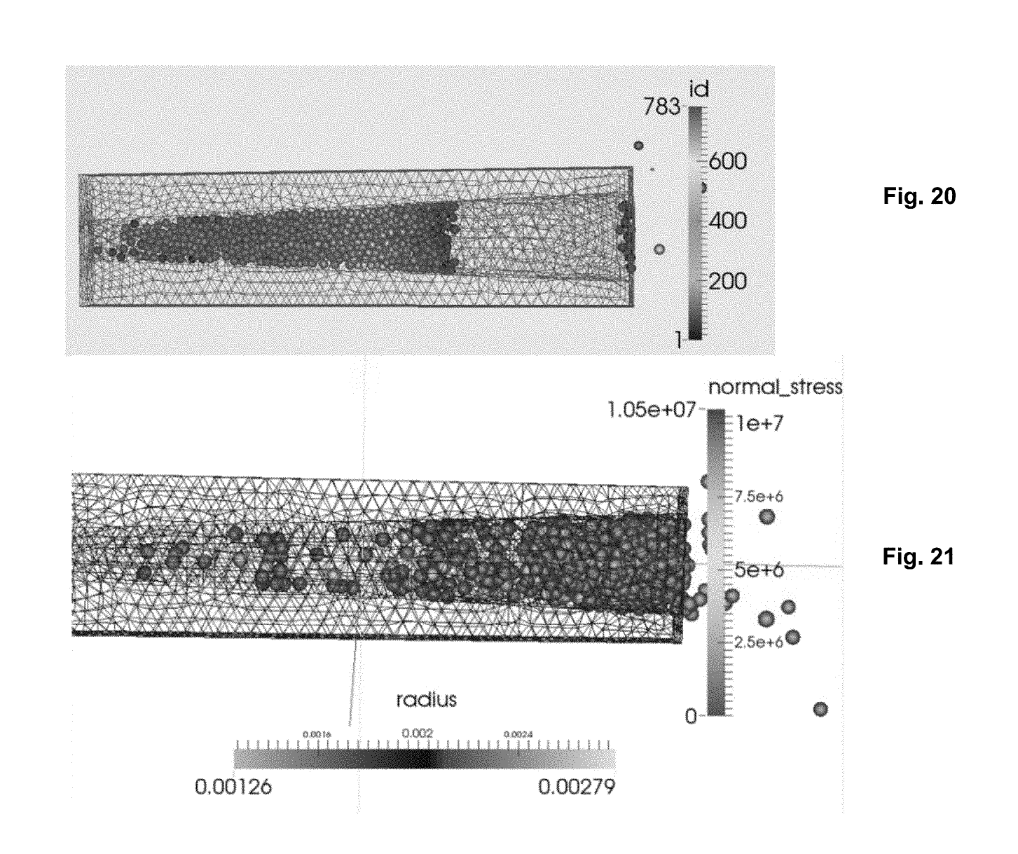

Finally, the number of particles needed to reach a pressure of 3500 psi was found as seen in FIG. 20. It could be seen that an average of 783 particles were needed to successfully plug a fracture of this size.

For the second simulation, the stress release of the smart LCM was being calculated. As the particles entered the fracture as seen in FIG. 21, they got exposed to heat and started activating and expanding. The mouth of the fracture was sealed and no more particles were able to enter due to the sealing of the fracture. The walls of the fractures were kept fixed with an elastic property. The normal stress released from the particles due to expansion was then measured. It can be seen that the smart LCMs in porous media release up to 10 MPa of stress. This stress can be very effective for strengthening the wellbore as mentioned above.

### Experimental Results

As mentioned above, experiments were made to test the sealing efficiency of the smart LCMs. The objective of running both experiments is to create a field environment of lost circulation at a small scale and see how effective our smart expandable LCM will seal it. The first experiment done to test the smart LCMs was permeability plugging apparatus (PPA) shown in FIG. 9.

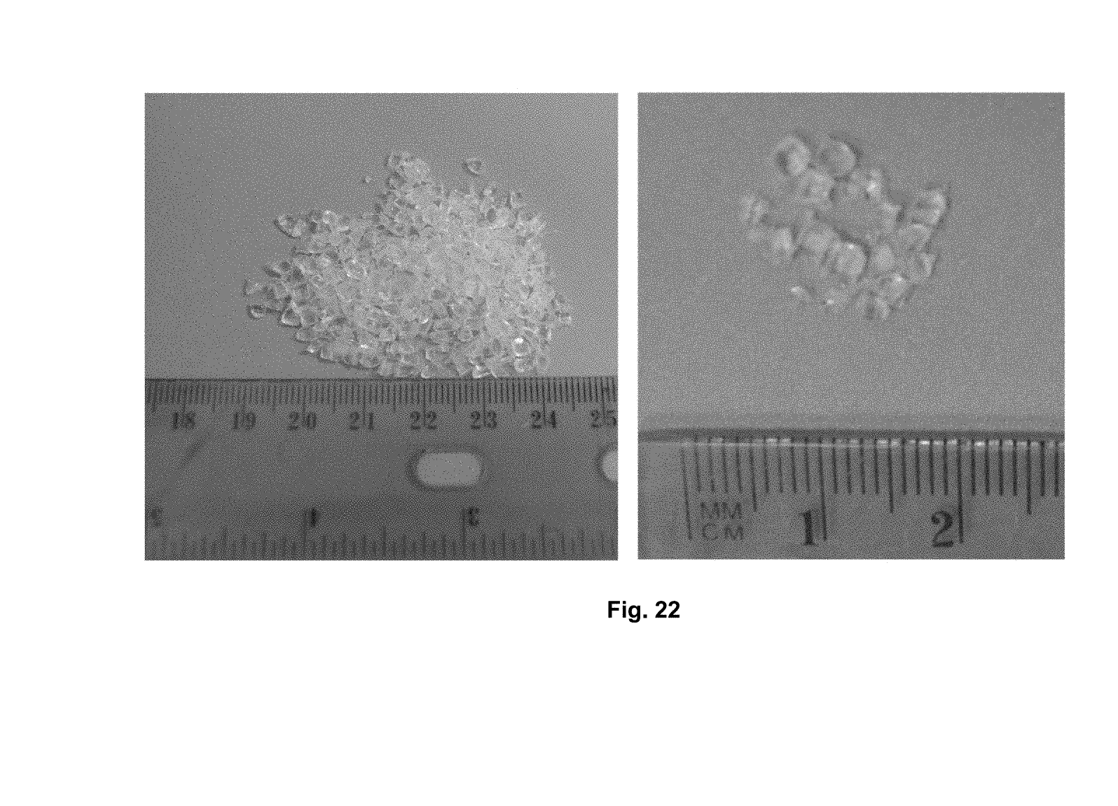

The particle plugging apparatus that was used is a high-pressure high-temperature instrument that has a maximum operating pressure of 5000 psi and a maximum operating temperature of 500 degrees Fahrenheit. The PPA assembly consists of a PPA Heating Jacket to heat up the apparatus to specific temperatures, a dial thermometer to measure the temperature, a hydraulic hand pump assembly to supply pressure, a 5000 psi stainless steel PPA cell where the fluid and LCM will be placed, a LCM PPA Receiver—without this receiver the PPA will get plugged and it will be very hard to run the experiment, a backpressure receiver this is used only if the temperature exceeds bubble point of the fluid, a carbon dioxide pressurizing assembly or nitrogen pressurizing assembly to work with the backpressure receiver, a graduated cylinder to measure the fluid loss and finally, slot discs and tapered discs to represent fractures. The smart LCMs were manufactured in two diameter sizes, 2.5 mm and 5 mm. The smart LCMs activation temperature is 70 Degrees Celsius. FIG. 22 shows the smart LCMs before and after activation.

The LCM receiver was filled with 170 ml of water-based mud that had a 0.04 Pa·s plastic viscosity mixed with 35 grams of particles with a mixture of the sizes mentioned above for the smart LCMs. One slotted disc and one tapered disc with descriptions described in Table 1 were used to represent the fracture.

TABLE 3
Example 4- Disc properties

| Type | Length (Inches) | Width (Inches) |
|---|---|---|
| Slot Disc | 0.279 | 0.1 |
| Tapered Disc | 1.700 | 0.04 to 0.1 |

For each disc, the heating jacket was preheated to 75 Degrees Celsius. The PPA cell was then inserted in the heating jacket and left there for one minute before applying pressure to allow the heat to be transferred to the cell for the activation of the smart LCMs. The fluid loss and the maximum pressure the seal can hold with respect to time were recorded. The fluid loss was measured by pumping hydraulic fluid in the cell at a rate of 2 strokes per 30 seconds. Since the fracture was sealing with time, fluid was being prevented from going through the fracture and the pressure was building up. This pressure build up was also recorded with respect to time. Table 2 shows the results that were obtained from this experiment for the Slot disc. Table 3 shows the results obtained from the tapered disc.

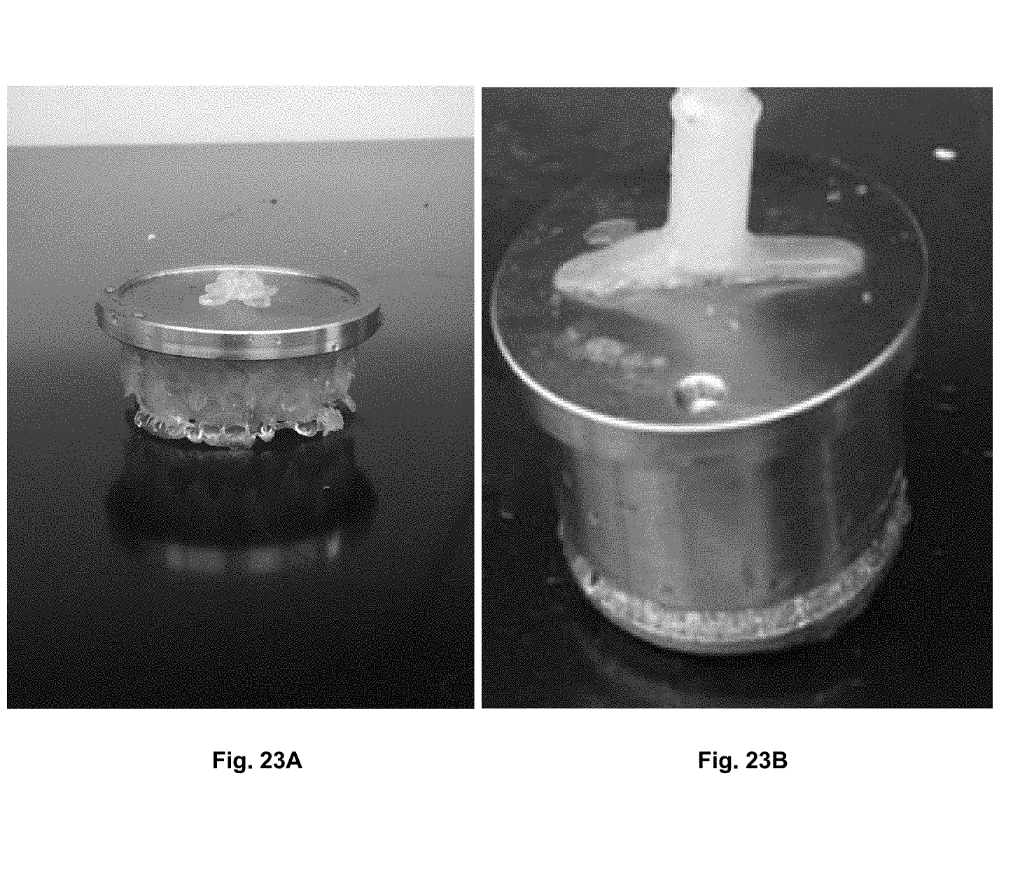

It can be seen from the results that the fluid loss decreased gradually to zero as the particles expanded and started bridging. The seal was very effective and was able to withstand very high pressures. The particles bridged together as seen in FIGS. 23A-B.

### Conclusion

Experimental results and numerical simulations indicate that the smart LCM can be a very effective tool for sealing fractures in bottomhole conditions. The results from simulation and experiments confirmed that the seal can handle up to 5000 psi differential pressure. The concentration of LCMs needed to seal the fracture would depend on the length of the fracture and whether the mouth or the full fracture is required to be sealed. The stress release of the smart LCM was seen to be 10 MPa in porous medium. This stress release will play an important role in decreasing the fracture's minimum horizontal stress and therefore, strengthen the wellbore.

### Example 4 References

1. Alberty, M. W. and McLean, M. R., 2004: “A Physical Model for Stress Cages.” Paper SPE 90493, presented in SPE Annual Technical Conference and Exhibition, Houston, USA.
2. Al-saba, M. T., R. Nygaard, A. Saasen, and O. M. Nes, 2014: “Lost Circulation Materials Capability of Sealing Wide Fractures,” Paper SPE 170285, presented in SPE Deepwater Drilling and Completions Conference, Society of Petroleum Engineers, Galveston, Tex., USA.
3. Arshad U, B. Jain, H. Pardawalla, N. Gupta and A. Meyer, 2014: “Engineered Fiber-Based Loss Circulation Control Pills to Successfully Combat Severe Loss Circulation Challenges During Drilling and Casing Cementing in Northern Pakistan,” Paper SPE 169343, presented at the SPE Latin American and Caribbean Petroleum Engineering Conference, Society of Petroleum Engineers, Maracaibo, Venezuela.
4. Brandl, A., Bray, W. S., Molaei, F., 2011: “Curing Lost Circulation Issues and Strengthening Weak Formations with a Sealing Fluid for Improved Zonal Isolation of Wellbores.” Presented in Australian Geothermal Energy Conference, Melbourne.
5. Cook J., F. Growcock, Q. Guo, M. Hodder and E. van Oort, 2012: “Stabilizing the Wellbore to Prevent Lost Circulation,” Oilfield Review 23, no. 4, 26-35.
6. Cundall, P. A., & Strack, O. D. L. (1979). A Discrete Numerical Model for Granular Assemblies. Geotechnique, 29(1), 47-65.
7. Dahi Taleghani, A., Li, G., Moayeri, M., 2016: “The Use of Temperature-Triggered Polymers to Seal Cement Voids and Fractures in Wells,” Paper SPE 181384-MS presented in SPE Annual Technical Conference and Exhibition in Dubai, UAE.
8. Dupriest, F. E., Smith, M. V., Zeilinger, C. S. and Shoykhet, I. N., 2008: “Method to Eliminate Lost Returns and Build Integrity Continuously with High-Filtration-Rate Fluid.” Paper SPE 112656, presented in SPE/IADC Drilling Conference, Orlando, Fla., USA
9. Fuh, G. F., Morita, N., Byod, P. A., and McGoffin, S. J. 1992: “A New Approach to Preventing Lost Circulation While Drilling.” Paper SPE 24599, presented at SPE Annual Technical Conference and Exhibition, Washington D.C., USA, 4-7 October
10. Kloss, C., Goniva, C., 2011: “LIGGGHTS—open source discrete element simulations of granular materials based on Lammps,” Supplemental Proceedings: Materials Fabrication, Properties, Characterization, and Modeling, Volume 2, 781-788.
11. Lendlein, A., & Kelch, S. (2002): “Shape memory polymers.” Angewandte Chemie International Edition, 41(12), 2034-2057.
12. Li, G. 2014: “Self-healing composites: shape memory polymer based structures.” Jon Wiley & Sons.
13. Morita, N., Black, A. D., and Fuh, G-F., 1990: “Theory of Lost Circulation Pressure.” Paper SPE 2040, presented in SPE Annual Technical Conference and Exhibition, New Orleans, La., USA.
14. Nygaard, R., Alsaba, M. & Hareland, G., 2014: “Review of Lost Circulation Materials and Treatments with an Updated Classification.” Presented in AADE National Technical Conference and Exhibition, Houston, Tex., USA.
15. Salehi, S. 2012: “Numerical Simulations of Fracture Propagation and Sealing: Implication for Wellbore Strengthening.” PhD dissertation, Department of Geological Sciences and Engineering, Missouri University of Science and Technology. USA.
16. Salehi, S. and Nygaard, R., 2012: “Numerical Modeling of Induced Fracture Propagation: A Novel Approach for Lost Circulation Materials (LCM) Design in Borehole Strengthening Applications of Deep Offshore Drilling.” Paper SPE 135155, presented in SPE Annual Technical Conference and Exhibition, San Antonio, USA.
17. Santos, L., A. Dahi Taleghani, Li, G., 2016: “Smart Expandable Proppants to Achieve Sustainable Hydraulic Fracturing Treatments,” Paper SPE 181391-MS presented in SPE Annual Technical Conference & Exhibition in Dubai, UAE.
18. Shor, R. J., & Sharma, M. M. (2014). Reducing Proppant Flowback From Fractures: Factors Affecting the Maximum Flowback Rate. SPE Hydraulic Fracturing Technology Conference. http://doi.org/10.2118/168649-MS
19. Van Oort, E., Friedheim, J., Pierce, T., and Lee, J., 2011: “Avoiding Losses in Depleted and Weak Zones by Constantly Strengthening Wellbores.” Paper SPE 125093, presented in SPE Drilling & Completion, USA
20. White, R. J., 1956: “Lost-circulation Materials and their Evaluation,” In Drilling and Production Practice. American Petroleum Institute.
21. Whitfill, D. L. and T. Hemphill, 2003: “All Lost-Circulation Materials and Systems Are Not Created Equal,” Paper SPE 84319, presented at the SPE Annual Technical Conference and Exhibition, Society of Petroleum Engineers, Denver, Colo., USA.
22. Xie, T., 2011: “Recent advances in polymer shape memory.” Polymer, 52(22), 4985-5000.
23. Zhu, H. P., Zhou, Z. Y., Yang, R. Y., & Yu, A. B., 2007: “Discrete particle simulation of particulate systems: theoretical developments.” Chemical Engineering Science, 62(13), 3378-3396.

### Example 5

One of the most important decisions that need to be made in drilling operations is to choose the right type and density of drilling fluids. Drilling fluids are used in drilling operations to provide a pressure overbalance in the bottomhole and prevent the wellbore from collapsing. They are also used to cool down the drilling bits and transport cuttings to the surface. However, in some incidents not all the drilling fluid is able to circulate back to the surface. Drilling fluid is sometimes lost to the formation through a fracture. Such incidents are called lost circulation. Lost circulation costs a lot of money due to unproductive time and if not controlled, serious environmental risks such as a blowout can occur (Arshad et al., 2014). Table 1 shows the costs of lost circulation according to API/Marlin Energy and service companies. It can be seen that controlling a lost circulation incident can take from 3 to 7 days. It becomes more expensive if the lost circulation is on an offshore rig than on an onshore rig. It was seen that most lost circulation incidents occur in highly permeable, karsted and naturally fractured formations (Al-Saba et al, 2014). Given that 26% of the wells around the world experience such problems, a solution to such problems should be found.

There are two known approaches available that could help prevent or minimize lost circulation. The first approach is called the preventive approach. This method can be used when the drilling engineer knows that a lost circulation event could occur due to drilling induced fractures, but lost circulation has not yet occurred. In this approach, lost circulation can be prevented by adding materials to the mud that will strengthen the wellbore and increase the minimum horizontal stress of the fracture, therefore, preventing a fracture from getting larger and causing the fluid to be lost. The second approach is called lost circulation treatment and can be achieved by adding materials known as lost circulation materials. When mixed with the mud, lost circulation materials have the ability to plug the fracture and seal it if their particle size is big enough to do so (Cook et al, 2012). The type, shape, composition and strength of the lost circulation materials (LCMs) are also very important when trying to design the most efficient solution for lost circulation (White, 1956). It is important to note that all lost circulation materials and wellbore strengthening materials work the same way but for different reasons. In this paper, we propose a smart expandable material made out of shape memory polymers that can act as both a wellbore strengthening material during the preventive approach and as a lost circulation material that seals and plugs the fracture. A bundle of the smart expandable materials in porous media have the ability to release 13 MPa of stress. This stress release increases the circumferential stress around the wellbore that may help to strengthen it.

Wellbore strengthening is essentially focused on increasing the fracture gradient to allow expansion of the mud weight window. Wellbore instability has been estimated to have economic losses of about 8 billion US dollars per year. To be able to understand how mud is lost to the formation while drilling and how to strengthen and stabilize the wellbore we need to understand the stresses around the wellbore and analyze them. In drilling operations, the mud is circulated in the bottomhole to keep the hole open and prevent the well from collapsing. Considering a vertical well in an anisotropic stress field, Equation 1 can define the effective hoop stress:

σ_{θ}=σ_{H}+σₕ−pₚ−pₘ−σ_{T}−2(σ_{H}−σₕ)cos 2θ (1)

The hoop stresses are the stresses of most interest when trying to prevent or treat mud losses. The only parameter that the drilling engineer can control in Equation 1 is the mud weight (pₘ). When the mud weight becomes too high, it can be seen that the hoop stress decreases. When the hoop stress starts to become negative or goes in tension, the fracture is induced. Wellbore strengthening materials are implemented to add compression to the tangential stress around the wellbore. Increasing the compressional hoop stress will prevent the fracture from propagating, thus prevent fluid losses. Based on this, research has been done to understand how wellbore strengthening materials can increase the hoop stress. Alberty and Mclean (2004) presented a stress cage model using a linear-elastic fracture mechanics model. The model explains that the hoop stress around the wellbore is enhanced and increased when wellbore strengthening materials seal the fracture mouth, thus isolating it from the mud pressure. The pressure in the isolated fracture then dissipates if the formation is permeable and goes to the formation pore pressure. Since the fracture is isolated, the pore pressure does not affect Equation 1 now. When the fracture attempts to close, it causes compressional forces on the wellbore that increases the hoop stress. Salehi (2012) tested the wellbore hoop stress enhancement theory using a 3D poro-elastic, finite element model. This model simulated fracture initiation, propagation and sealing of the fracture mouth. Simulation results showed that if the fracture mouth is effectively sealed, the hoop stress around the wellbore would be increased and restored, confirming Alberty and Mclean (2004) model.

### Lost Circulation Materials

It was estimated that lost circulation alone accounted for US $2-$4 billion annual costs due to lost time. Lost circulation not only causes non-productive time, uncontrolled loss of fluid can also damage the reservoir's formation and have a negative effect on its production potential and therefore, causing even more future losses. In the Gulf of Mexico, lost circulation, stuck pipe, sloughing shales and wellbore collapse account for 44% of the total non-productive time (Cook et al., 2012). The use of synthetic-based muds that range from $100 to $200 per barrel make losing these fluids extremely costly. The more the non-productive time, the higher the cost.

As mentioned above, to treat lost circulation, lost circulation materials are added to the mud. Lost circulation materials work in a way to make particles in the mud increase in size in order to plug the pores or cracks that mud alone can't seal. This then prevents mud from being lost to the formation (White, 1956). These materials must have special characteristics in which the materials' particles have to be large enough to seal the largest cracks present (White, 1956). If the size of the particles is too small, the particles will flow through the fractures. Similarly, if the size of the particles is too large, the particles will not be able to enter the fracture and therefore, won't be able to seal it. Therefore, the perfect size of the material's particles is very important so that losses can be treated properly (Jain et al., 2013). The materials should also be able to adapt to a wide range of environments, temperatures and pressures. The seal formed by the LCMs should be able to withstand mechanical forces that come from drilling practices, erosional forces that come from the fluid velocities and hydrodynamic forces that come from swab and surge (Cook et al., 2012). Lost circulation materials are classified as fibrous, flaky, granular types or a mixture of the three types (White, 1956). The LCM can be effective if it bridges correctly and efficiently in the fracture. In order to make sure that the LCM bridges correctly, researchers have come up with theories to maximize bridging. Bridging of particles is defined as the buildup of solids in porous formations to minimize losing fluids. Various bridging theories are available and their main goal is to increase the particles' capability to bridge. Abrams (1977) proposed two rules to minimize formation damage due to lost circulation and mud invasion. The first rule says that the average particle size (D50) of the bridging materials or LCMs should be equal or slightly larger than a third of the average formation pore size. The second rule suggests that the LCM concentration should not be less than 5% by volume of the total solids in the mud formation. Whitfill (2008) proposed a theory to optimize bridging using fracture width instead of pore throat sizes. The average particle size of the LCM should be equal to the fracture width to make sure that the fracture is effectively plugged. Vickers (2006) suggested that D10, D25, D50, D75 and D90 should all be taken into consideration when picking the diameter of the LCM particle. He suggests that: 1) D10 should be greater than the smallest pore throat, 2) D25 equal to about one seventh of the average port throat size, 3) D50 the same as Abrams (1997), 4) D75 less than two third of the largest pore throat, and 5) D90 equal to the largest pore throat.

Though these studies highlight the effectiveness of LCMs, there are still disadvantages. The biggest disadvantage LCMs face today is the ability to seal big fractures; when the fracture is too big to seal, LCMs fail to bridge properly to seal it. The second disadvantage will be failure to work in high-pressure, high-temperature (HPHT) environments; the LCM seal is either not able to withstand the high pressures or it will melt due to high temperatures. Thirdly, some LCMs, if not acid soluble, will cause damage to production zones and therefore affect oil production. This could be a serious problem and cost companies a lot of money. Finally, plugging of drilling tools has been an issue. LCMs that are big in size sometimes plug the tools and therefore will also cost drilling companies money to fix the issue in addition to the lost circulation incident.

Looking at the disadvantages above, it is very clear that we need an LCM that can go through the drilling tools without plugging it, and then through some sort of expansion has the ability to plug a big fracture and strengthen the wellbore. The smart LCM we disclose is made out of shape memory polymers and has the ability to do that. Preliminary results in testing the sealing efficiency of the smart LCMs have been presented in earlier works (Mansour et al., 2017, Mansour et al., 2017).

### Shape Memory Polymers

The shape memory effect was first discovered by Chang and Read in 1932. Shape memory polymers are polymers that have the ability to be deformed and fixed into a temporary shape. They are then able to recover to their original permanent shape only when they are exposed to a specific external stimulus such as light, magnetic field, temperature, moisture, or pH. Not all polymers can be fixed in a temporary shape. For example, rubber can change shape whenever it's loaded, but when the load is removed the rubber goes back instantaneously to its original shape and no fixing of the temporary loaded shape has occurred. However, when the shape memory polymers are deformed when loaded they have the ability to trap mechanical energy as internal energy, and release this energy whenever an external stimulus causes a change in the molecular relaxation rate or in material morphology (Li, 2014). Shape memory polymers do not only have this shape-changing advantage but they are also cheap, lightweight, nontoxic, biocompatible and biodegradable (Ratna and Karger-Kocsis, 2008).

The smart LCMs proposed here will have temperature as an external stimulus. Shape memory polymers with temperature as an external stimulus can be either thermoset or thermoplastic. Thermoset SMPs are chemically cross-linked polymers. They are usually preferred in engineering structures due to their high stiffness, high strength, high dimensional stability and high corrosion resistance as compared to thermoplastic SMPs. During the shape recovery process, thermoplastic SMPs melt and therefore may not be a good chemical to use for the smart LCM. The smart LCMs proposed here will be made out of thermosetting shape memory polymers.

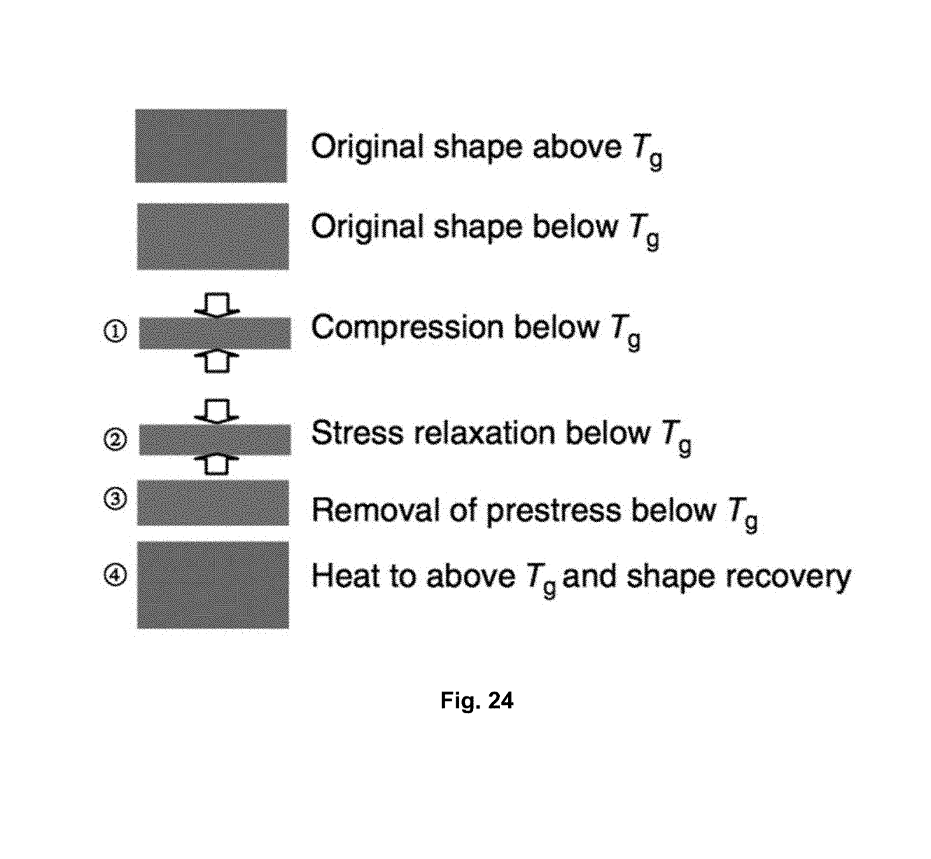

Noticing these advantages of the shape memory polymers, we can see that such expansive properties can help when dealing with tool plugging. Such shape-changing properties will allow the smart LCM to be in a small size when entering the tool and then expand at a specific temperature within the fracture, therefore sealing the fracture and preventing plugging of tools. Since the smart LCM is biodegradable, it will not cause any damage to production zones since it can be dissolved in solvent. Because the smart LCM will also have stress stored in it and released whenever a specific temperature acts on it, the wellbore can be strengthened by this stress release. Before we explain how the smart LCM will recover in the wellbore, there is a process called SMP programming that needs to be done to achieve such recovery. Programming is the process that fixes the SMP in the temporary shape. A four-step thermomechanical cycle can explain how the SMP is programmed as seen in FIGS. 16 and 24.

Such programming is called cold programming because the programming is conducted in the glassy state (Li and Xu, 2011; Li and Wang, 2016). From FIG. 16, the original shape of the SMP is prestressed and put under compression at a temperature below the glass transition temperature (TO. The glass transition temperature is the temperature at which the thermosetting SMPs go from being in a hard state to a pliable state. The second step is called stress relaxation and it happens while keeping the strain constant but relaxing the stress. The third step is removing the load. This complete the programming. As for recovery, it has two representative modes. One is free shape recovery, as shown in the fourth step in FIGS. 16 and 24. This happens whenever the SMP is heated to above T_{g}. It can also show stress recovery, as illustrated in step 5 in FIG. 16. Step 5 happens when the recovery is constrained and it is called constrained stress recovery. It consists of two components, the first being stress due to shape recovery and the second is thermal stress release from the thermal expansion occurring due to heating. Whenever the shape memory polymers are in a totally constrained environment and their shapes are fixed, they release stress using the two components mentioned above. It is important to subtract the thermal stress from the total stress release of the SMP to obtain the memorized stress. It can be seen in FIG. 16 that the stress in step 5 will peak then decrease again; this peak is because of the thermal and entropic stresses. Subtracting the thermal stress will give a constant and more reliable stress release from the SMP. The thermal stress release can be calculated using Equation 2 as follows:

σ_{Thermal}=EαΔT (2)

Siskind and Smith (2008) developed an equation to calculate the total stress released from the SMP. The equation also includes the stress release due to thermal expansion and the entropic stress released due to shape recovery. Equation 3 shows the total stress release from the SMP. The authors explain that the SMP has an initial volume and when this volume changes due to temperature there will be a frozen volume portion (ø_{f}) and an active volume portion (øₐ). The active volume is the sum of the strain from the entropic and thermal components, while the frozen volume is the stable shape recovery. The strains from both components are then subtracted from the total strain (∈) of the SMP and multiplied by the Youngs Modulus (E) to calculate the total stress release of the SMP. The total strain can be calculated using Equation 4. More information on how the equation is derived can be found in their reference.

$$\begin{matrix} {σ}_{SMP} = E ( ε - {\int }_{0}^{{∅}_{f}} {ε}_{f}^{e} ( x ) d ∅ - {\int }_{{T}_{0}}^{{T}_{g}} [ {∅}_{f} {α}_{f} + ( 1 - {∅}_{f} ) {α}_{a} ] dT ) & ( 3 ) \\ ε = \frac{1}{V} {\int }_{0}^{{V}_{frz}} {ε}_{f}^{e} dV + [ {∅}_{f} {ε}_{f}^{i} + ( 1 - {∅}_{f} ) {ε}_{a}^{e} ] + [ {∅}_{f} {ε}_{f}^{T} + ( 1 - {∅}_{f} ) {ε}_{a}^{T} ] & ( 4 )\end{matrix}$$

For calculation of the memorized stress, Wang and Li (2015) also considered the stress relaxation effect during stress recovery. They proposed that the memorized stress is the difference between the measured stress by the MTS machine and the thermal stress and stress relaxation. They used a simple stress relaxation equation to calculate the relaxed stress.

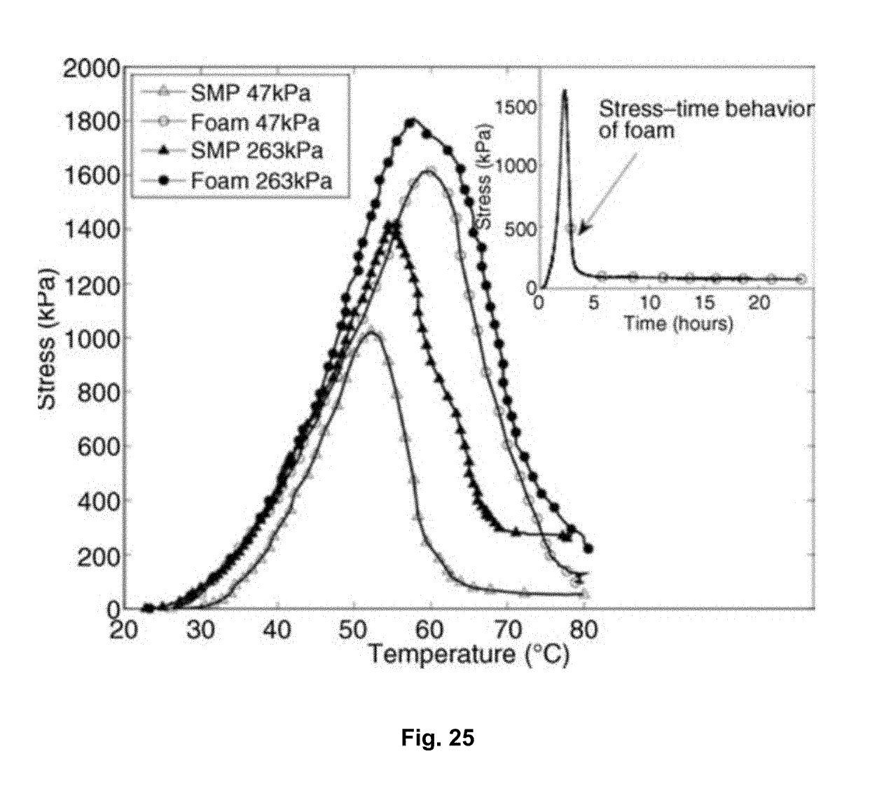

According to Li (2014) the stress release was measured using an MTS Q-TEST 150 machine with a fully constrained recovery. It can be seen that the thermal stress release can go up to 1.8 MPa. FIG. 25 shows the stress release of the SMP in particle form versus foam (Li and Nettles, 2010). Both of these SMPs were also pre-stressed with two different stress values. It can be seen that the more the SMP is pre-stressed, the higher the stress release. It can also be seen that the values can be high and therefore, the memorized stress release of the SMP should be calculated by subtracting the thermal stress release from it. Even after all of these subtractions are made the SMP can release up to 13 MPa of stress in porous media, meaning that it will cause compressional forces on the wellbore hoop stress. These compressional forces will therefore prevent the hoop stress from going into tension and therefore help in preventing the fracture to propagate. Finally, whenever a bundle of SMPs are present and are activated above T_{g}, their rubbery state allows them to bridge and connect together, forming an effective strong seal that isolates the fracture from the wellbore. Therefore, there is a stress release advantage and a bridging advantage for having LCMs made out of thermoset SMPs. Isolating the fracture and causing compressional forces increase the chance of preventing the hoop stress from going into tension. SMPs have also been used as proppants (Santos et al., 2016), for refracturing operations (Santos et al., 2017) and in cementing applications (Taleghani et al., 2017).

### Static Fluid Loss Experiments; Procedure and Results

In this section, the smart LCM proposed in this paper was tested for its expansive and sealing properties using the Particle Plugging Apparatus (PPA) as seen in FIG. 9. The PPA is a high-pressure, high-temperature apparatus that can withstand up to 5000 psi and 500° F. Two experiments were made using this apparatus.

The PPA consists of a hydraulic pump, a PPA cell, a LCM-receiver, a slot or tapered disc to represent the fracture in the formation, a thermostat to adjust the temperature and a thermometer to measure the temperature. The PPA cell is usually filled with a mixture of drilling fluid and LCMs and then the slot disc is inserted on top of this mixture. The PPA cell has a floating piston in it that seperates the oil coming from the hydraulic pump from the mixture of mud and LCM. The LCM-Receiver is then tightly capped at the top of the PPA cell and has a nozzle to allow the fluid that is lost from the PPA cell to be measured. The hydraulic pump is connected to the bottom of the PPA cell, where oil pushes the floating piston and if the slot or tapered discs are sufficiently sealed, pressure builds up; if not, then fluid is lost and collected from the nozzle of the LCM-Receiver.

The objective of the first experiment was to test the volumetric change property of the LCM as a function of pressure. Since this is a partially constrained environment, the smart LCM will not be able to fully recover to its shape due to pressure from the bottomhole. The particles used in the experiments had an activation temperature of 75° C. and they had a disc shape. Two particles were picked and their diameter, thickness and mass were measured. These two particles were then mixed with a water-based mud and put in the PPA cell. A disc with no fractures was used instead of a slot disc to allow the pressure to build up in the PPA cell. Oil was pumped from the hydraulic pump to raise the pressure until 3000 psi and then the temperature was raised to 80° C. and kept constant for 30 minutes. The pressure was then dropped gradually until it reached zero and the particles were then cooled down to room temperature, 23° C. The particles were then taken out from the PPA cell and their diameter, thickness and mass were measured. This experiment was repeated for pressures of 0 psi, 1000 psi and 2000 psi. Each experiment was also repeated twice to decrease the chance of error. It was noticed that there were no changes in mass. Table 2 shows the size of the smart LCM before and after expansion at each pressure.

TABLE 2
Example 5. Results from Experiment One

| | | | |
|---|---|---|---|
| 0 | 1000 | 2000 | 3000 |
| psi | psi | psi | psi |

First Test

| | | | | |
|---|---|---|---|---|
| Initial Diameter (mm) | 5.05 | 5.21 | 6.14 | 4.29 |
| Thickness (mm) | 1.82 | 1.96 | 2.02 | 1.81 |
| Diameter After Expansion (mm) | 4.82 | 4.97 | 5.49 | 4.2 |
| Thickness After Expansion (mm) | 3.36 | 3.33 | 2.84 | 1.95 |
| Dv/v | 0.755 | 0.607 | 0.194 | 0.0354 |

Second Test

| | | | | |
|---|---|---|---|---|
| Initial Diameter (mm) | 5.55 | 4.91 | 5.07 | 5.5 |
| Thickness (mm) | 2.39 | 1.79 | 2.03 | 2.01 |
| Diameter After Expansion (mm) | 5.23 | 4.17 | 4.67 | 5.47 |
| Thickness After Expansion (mm) | 4.65 | 3.21 | 2.69 | 2.07 |
| Dv/v | 0.830 | 0.492 | 0.167 | 0.019 |

Average Dv/v for Both Tests

| | | | | |
|---|---|---|---|---|
| Average dv/v | 0.79 | 0.55 | 0.18 | 0.03 |

The change in volume (dv/v) was calculated by its variation with respect to changes in its radius and thickness

$${( \frac{dv}{v} )}_{SMP} = 2 \frac{δ r}{r} + \frac{δ h}{h} \qquad ( 6 )$$

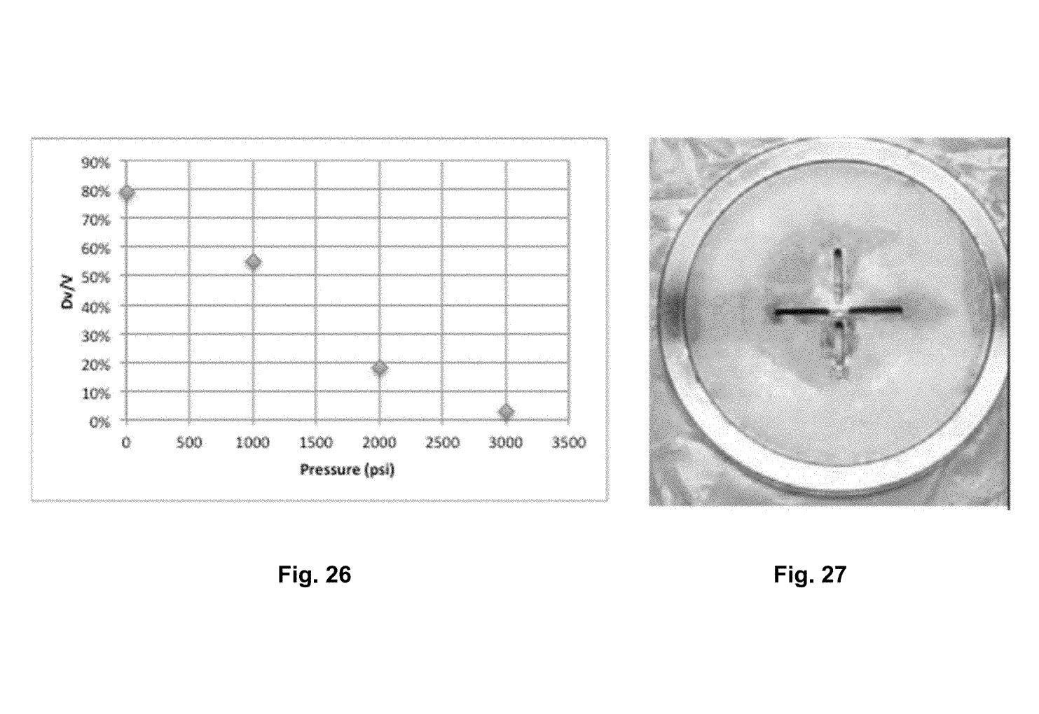

The average dv/v was then plotted versus the pressure applied as seen in FIG. 26. It can be seen that there is almost a linear relationship between the change in volume of the SMP and the pressure. The higher the pressure is, the harder it is for the SMP to expand and recover its original shape. At 0 psi this is the maximum recovery that the shape can restore, which is considered the permanent shape that the SMP had before it was programmed.

The objective of the second type of experiment made was to test the sealing efficiency of the smart LCM. 150 ml of water-based mud with a viscosity of 50 cp was mixed with smart LCMs that had an average diameter size of 5.87 mm and an average thickness of 1.63 mm. The mixture was then placed in the PPA cell. A slot disc of length 0.279 in. (7.08 mm) and width of 0.1 in. (2.54 mm) was used to represent the fracture in the formation as seen in FIG. 26 and placed on top of the PPA cell.

The LCM receiver was then tightly capped onto the PPA cell and the hydraulic pump was attached. The thermostat was then adjusted to 80° C. and the mixture was left to settle at this temperature for 5 minutes. After that, oil was pumped from the hydraulic pump at a rate of 2 strokes per 30 seconds. Each time oil was pumped, the fluid loss and the pressure that the seal can hold was recorded as seen in Table 3. The pressure reached to 3000 psi and was not allowed to exceed it. The seal that the smart LCMs was made can be seen in FIG. 11.

TABLE 3
Example 5. Results for smart LCMs activated at 80° C.

| Time | Pressure | Fluid Loss |
|---|---|---|
| (seconds) | (psi) | (ml) |
| 0 | 0 | 14 |
| 30 | 0 | 11 |
| 60 | 50 | 10 |
| 90 | 150 | 7 |
| 120 | 300 | 5 |
| 150 | 450 | 3 |
| 180 | 600 | 0 |
| 210 | 1200 | 0 |
| 240 | 1800 | 0 |
| 270 | 2400 | 0 |
| 300 | 3000 | 0 |

From FIG. 26, we know that the particles expand by about 3% when under 3000 psi. Therefore, to understand if these particles can plug the fracture below activation temperature for example at 23° C. we did two tests. The first test was to see if the particles at a non-expanded size of 5.87 mm diameter and 1.63 mm thickness can seal the fracture alone without expanding and without needing temperature to activate them. Assuming that the only reason the smart LCMs sealed the particles was because they expanded in size then we conducted the second test. With the expanded size of the LCM which would be particles that have 5.48 mm diameter size and 1.87 mm thickness at room temperature, we want to see if it will plug the fracture. Tables 4 and Table 5 shows the results of these two tests.

TABLE 4
Example 5. Results for the non-expanded LCM at 23°
C. or the expanded LCM at 23° C.

| Time | Pressure | Fluid Loss |
|---|---|---|
| (seconds) | (psi) | (ml) |
| 0 | 0 | 27 |
| 30 | 0 | 25 |
| 60 | 0 | 20 |
| 90 | 0 | 29 |
| 120 | 0 | 18 |
| 150 | 0 | 12 |
| 180 | 0 | 10 |

TABLE 5
Example 5. Results

| Time | Pressure | Fluid Loss |
|---|---|---|
| (seconds) | (psi) | (ml) |
| 0 | 0 | 24 |
| 30 | 0 | 23 |
| 60 | 0 | 28 |
| 90 | 0 | 16 |
| 120 | 0 | 22 |
| 150 | 0 | 23 |
| 180 | 0 | 9 |

It can be seen from the results above that the expansive property is not the only reason that the LCM seals the fracture. What makes the smart LCM an excellent choice for sealing fractures is that it has the ability to take the shape of the fracture by bridging and sticking together and at the same time still being able to withstand very high pressures.

### Dynamic Fluid Loss Experiment: Procedure and Results

The objective of the dynamic fluid loss experiments conducted in this study is to quantify the fracture sealing efficiency of the smart LCM. Table 6 shows the experimental design where the mud blend and temperature are two independent variables. The dependent variable is the cumulative mud loss. Water-based mud (WBM) was used as the control base fluid. Table 7 shows that the control base fluid was formulated with mud additives that would have little to no impact on the fluid loss and filtration property. 5 lb/bbl of the swellable polymer LCM was used in formulating the second recipe as shown in Table 8 and Table 9. Based on the fluid loss test results from the second recipe and some preliminary tests, a combination of the smart LCM and fiber LCM, 5 lb/bbl each, was used in formulating the third recipe. 120° F. and 212° F. were chosen as the low and high temperature levels respectively, and 10 ppg was selected as the design mud weight.

TABLE 6
Example 5. Design of experimental table

| Mud Blend | Temp. 1 (120° F.) | Temp. 2 (212° F.) |
|---|---|---|
| Base Mud | Test 1 | Test 4 |
| Polymer Blend | Test 2 | Test 5 |
| Polymer/Fiber Blend | Test 3 | Test 6 |

TABLE 7
Example 5. Base mud formulation

| Products | lb/bbl | % by weight | % by volume |
|---|---|---|---|
| Water | 319.2 | 75.9 | 91.2 |
| Gel | 20.0 | 4.8 | 2.4 |
| Caustic Soda | 0.5 | 0.1 | 0.1 |
| Lignite | 4.0 | 1.0 | 0.8 |
| Desco | 4.0 | 1.0 | 0.7 |
| Barite | 72.8 | 17.3 | 4.9 |

TABLE 8
Example 5. Smart LCM mud formulation

| Products | lb/bbl | % by weight | % by volume |
|---|---|---|---|
| Water | 313.0 | 74.4 | 89.4 |
| Gel | 20.0 | 4.8 | 2.4 |
| Caustic Soda | 0.5 | 0.1 | 0.1 |
| Lignite | 4.0 | 1.0 | 0.8 |
| Desco | 4.0 | 1.0 | 0.7 |
| Polymer LCM | 5.0 | 1.2 | 1.7 |
| Barite | 74.0 | 17.6 | 4.9 |

TABLE 9
Example 5. Smart/fiber LCM mud formulation

| Products | lb/bbl | % by weight | % by volume |
|---|---|---|---|
| Water | 310.0 | 73.7 | 88.6 |
| Gel | 20.0 | 4.8 | 2.4 |
| Caustic Soda | 0.5 | 0.1 | 0.1 |
| Lignite | 4.0 | 1.0 | 0.8 |
| Desco | 4.0 | 1.0 | 0.7 |
| Polymer LCM | 5.0 | 1.2 | 1.7 |
| Fiber | 5.0 | 1.2 | 1.0 |
| Barite | 72.0 | 17.1 | 4.8 |

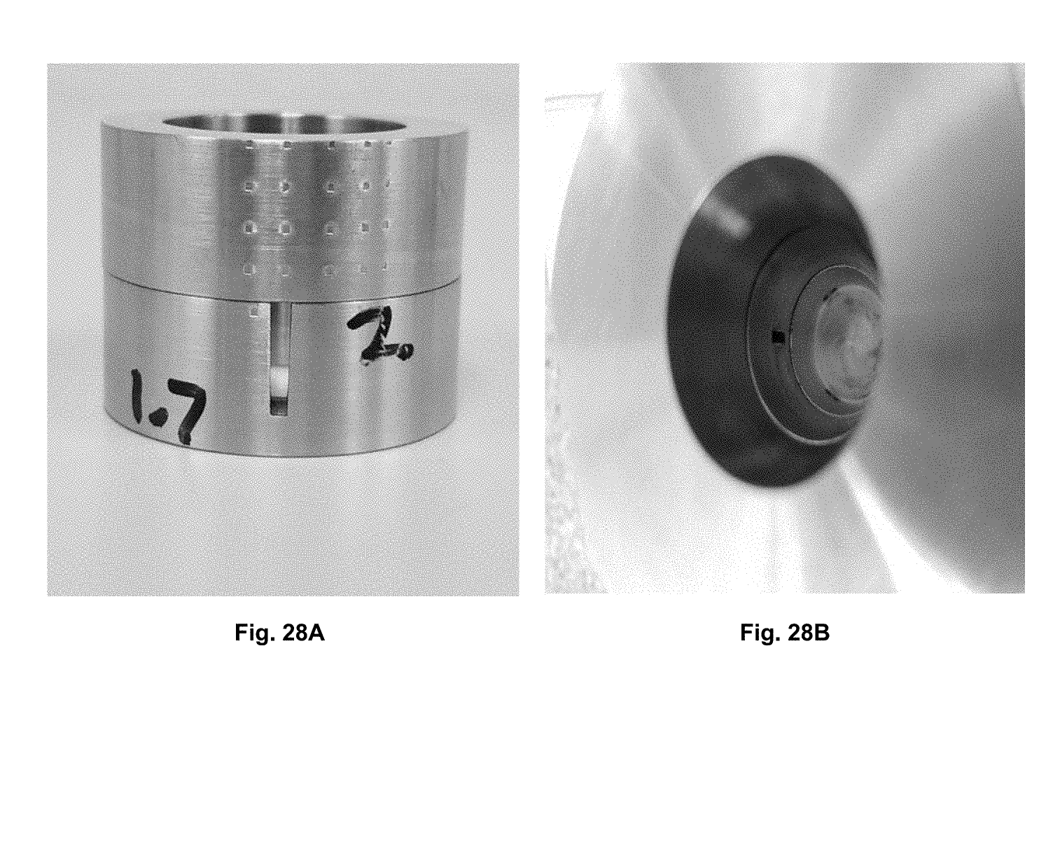

According to Ghalambor et al. (2014), lost circulation and drilling fluids invasion are classified into losses through pore throats, losses through induced and natural fractures, and losses through vugs and carvens. In this study, a 2000-micron width fracture cylindrical slot was used because this fracture size falls within the range of typical induced fracture widths observed from Petrophysics image logs. In addition, Alsaba et al. (2015) performed similar static condition tests using this fracture size. FIG. 28A shows two parts (top and bottom) of the cylindrical core slot. The bottom part shows the fracture orientation and a fracture length of 10,000-mircons. The dimensions of the entire cylindrical slot are: O.D=1.5 inches, I.D=1.0 inches, length=1.1 inches. FIG. 28B shows that the core slot is carefully secured inside a core holder such that the only fluid exits from the entire system would be through the fracture.

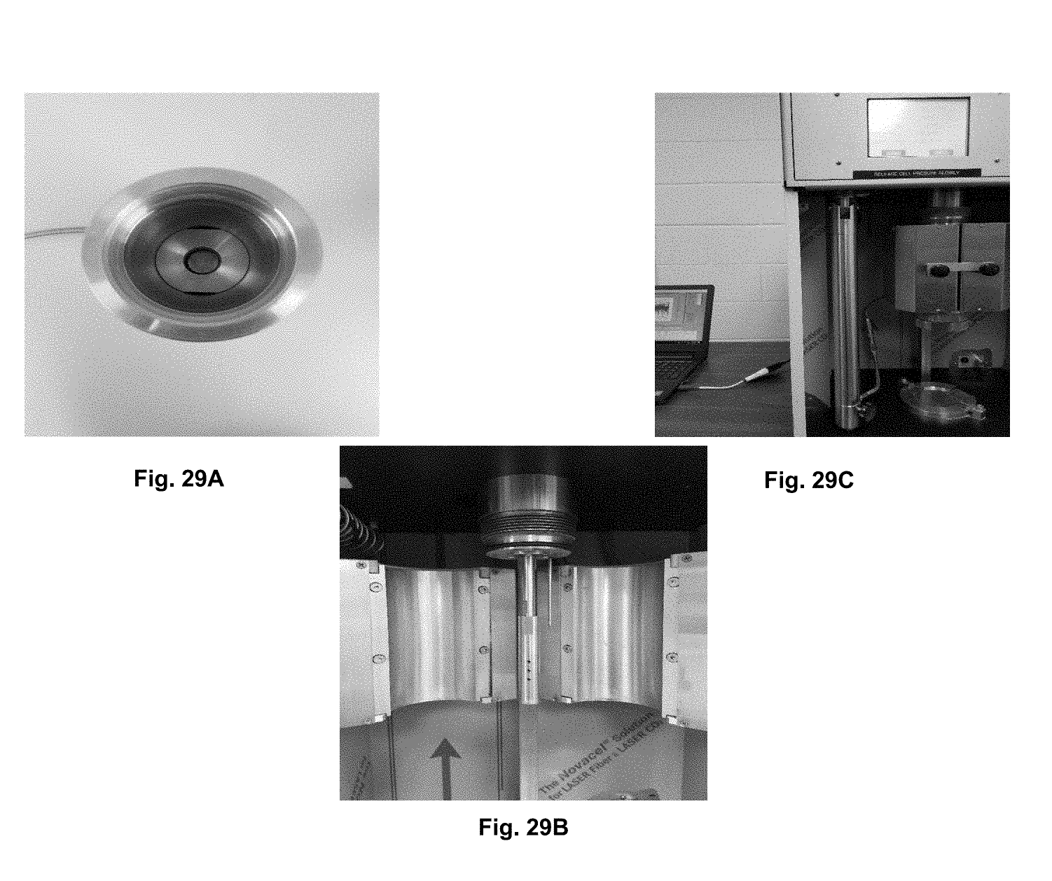

Furthermore, most of the experiments that have been used to quantify fracture-sealing efficiency of LCM drilling fluids have been conducted in static conductions (Alsaba et al., 2015, Guo et al., 2014, Kumar et al., 2011, Hettema et al., 2007, Aston et al., 2004). In real-time drilling, bottomhole conditions are often in a dynamic mode, and a greater percentage of drilling fluids invasion occur during this time because the inertia state of the mud is surpassed by the hydrodynamic condition of mud particles and the fluids shearing action (Ezeakacha et al., 2016). FIGS. 29A-C show the various stages of setting up the machine used in characterizing dynamic drilling fluid loss, for wellbore-shaped core samples and slots. The experimental procedure was programmed to track real-time data every 5 second, and operating parameters include but are not limited to fluid loss through the fracture, rotary speed, temperatures (bath and sample), and pressures (back and cell). Based on previous tests and preliminary calibrations, 50 RPM, 100 psi, and 200 psi were chosen as the rotary speed, back pressure, and cell pressure, respectively.

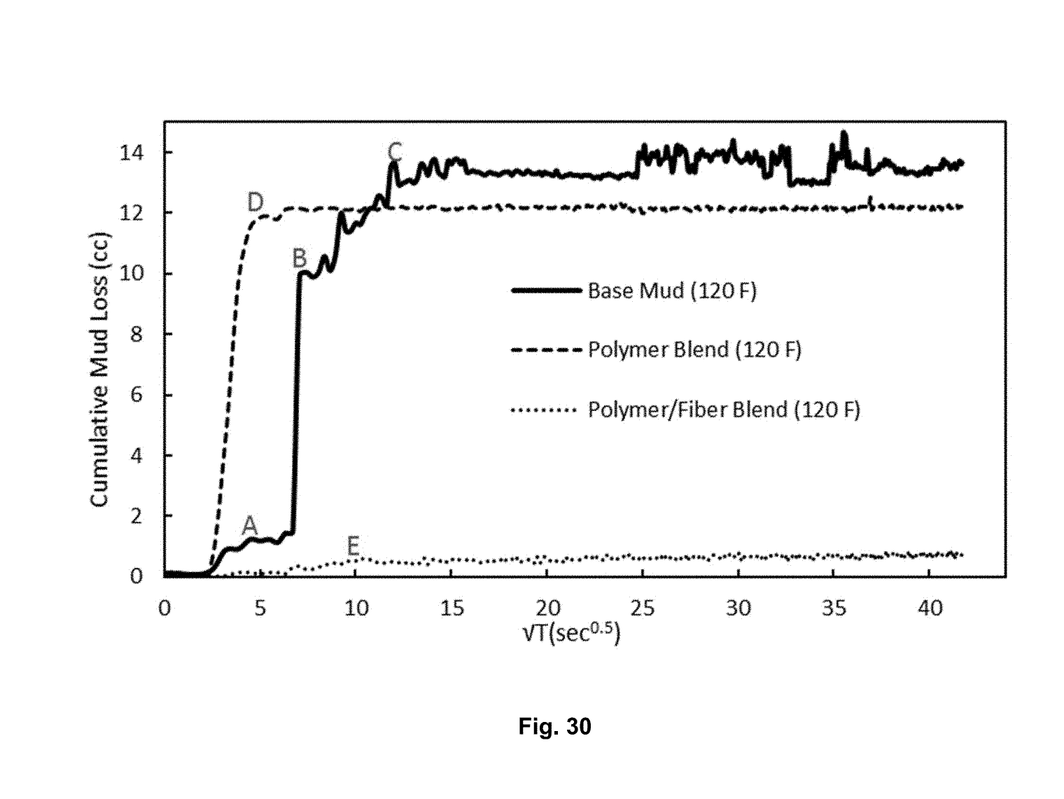

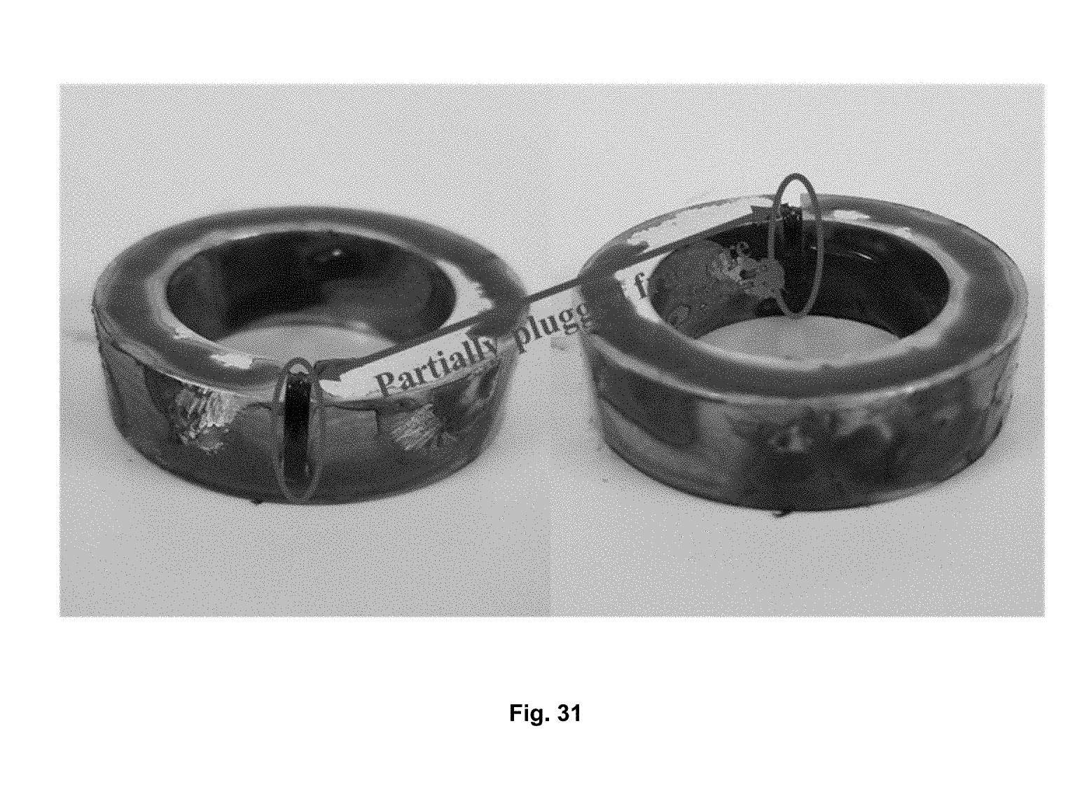

The results from the dynamic fluid loss experiments are presented from FIGS. 30 to 33. The alphabetical nomenclatures are used to denote points of interest during data acquisition and analyses. FIG. 30 shows the mud loss patterns at 120° F. For the base mud, the first significant loss was recorded as 1.448 cc, after 40 seconds and at 40 psi differential pressure. Point B showed the most significant loss of 10.052 cc after 65 seconds at 49 psi differential pressure. The gradual increase from point B to C indicates the formation of filter cake within the fracture. After 3 minutes and 15 seconds, 13.672 cc was collected at 103 psi differential pressure. This was the cumulative loss for this experiment. With the swellable polymer LCM mud, the first and only notable loss occurred between 10 and 20 seconds. Point D shows that at 20 seconds, 11.469 cc was collected at 18 psi differential pressure. Further increase in pressure showed very minimal loss because the cumulative loss at the end of the experiment was 12.203 cc. In addition, the 100 psi differential pressure target was achieved after 3 minutes. Although the difference in final volumes of the base mud and swellable polymer blend is 1.496 cc, the plots reveal that the polymer blend exhibited better filter cake quality and stability after its loss through the fracture. A combination of fiber with the polymer blend resulted in better sealing efficiency. Stable filter cake was formed within the fracture, and this is evident from the steady but minimal increase in filtrate loss from point E onwards. The cumulative filtrate loss using this optimum LCM recipe (swellable polymer/fiber blend) at 120° F. was 0.818 cc. In a similar study involving vertical fracture creation and seal at 120° F., Ezeakacha et al. (2017) recorded 26.7% decrease in cumulative filtrate loss using a wellbore strengthening material recipe. FIG. 31 shows the O.D and I.D of the bottom part of the fracture core slot, after the polymer/fiber blend experiment. The LCM particles can be seen within the fracture, and a fiber particle can be visually observed towards the right side of the I.D, very close to the fracture opening.

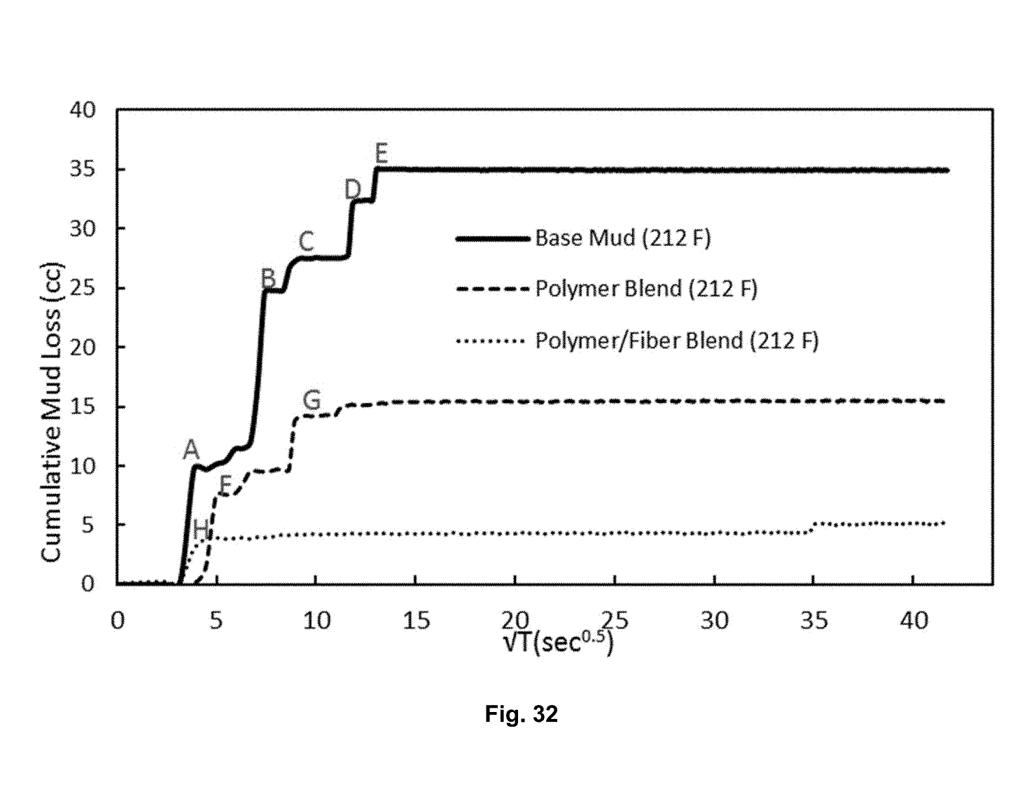

FIG. 32 shows the mud loss patterns at 212° F. Five notable points were observed for the base mud experiment. The first significant loss occurred from 5 to 15 seconds. At point A (15 seconds), 9.79 cc was collected at 21 psi differential pressure. There were signs of gradual filter cake evolution for the next 30 seconds, but an increase in differential pressure up to 53 psi damaged the thin filter cake and reopened the fracture. This resulted in 24.795 cc after 1 minute at point B. Cook et al. (2016) commented on a similar observation. They studied the mechanical performance of a thick and thin external filter cake, on a narrow and wide fracture opening respectively. The result of their study revealed that a thin filter cake would move more rapidly into the fracture than the thick filter, in response to differential pressure increase. Points C, D, and E are all in response to an increase in differential pressure for 62 psi, 78, psi, and 90 psi respectively. A total of 35.052 cc was collected.

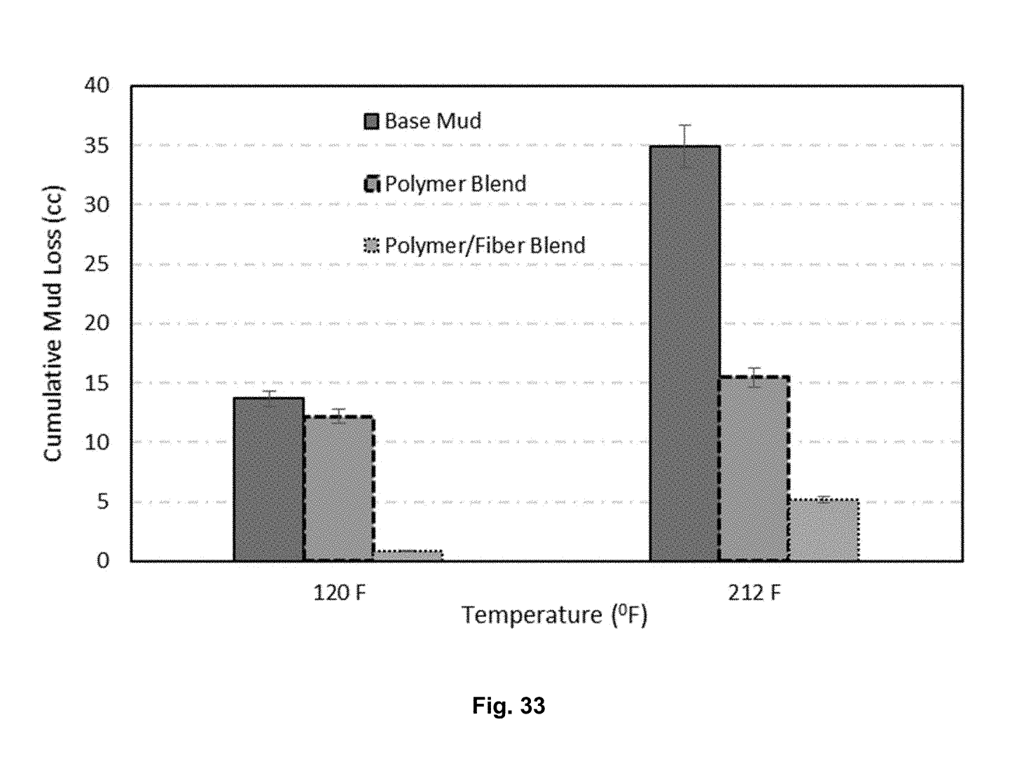

In the swellable polymer mud experiment, the first notable loss occurred at 25 seconds. Point F shows that at 25 seconds, 7.534 cc was collected at 9 psi differential pressure. The next 1 minute revealed filter cake build up until a 55 psi differential pressure surged the mud loss to 13.777 cc at point G. From this point onwards, increase in pressure resulted in minimal filtrate loss, and the cumulative loss was recorded as 15.456 cc. Like the experiment at 120° F., a combination of fiber with the swellable polymer blend resulted in better sealing efficiency at 212° F. A stable filter cake was formed within the fracture at point H, and this is evident from the steady but very minimal increase in filtrate loss from this onwards. 5.173 cc was the cumulative filtrate loss from the polymer/fiber LCM recipe at 212° F. The LCM particles could be visually observed to have plugged the fracture completely, thus reducing the amount of fluid loss at the operating conditions. FIG. 33 shows the comparison of all the cumulative loss data. The polymer blend has been reported to swell and expand at temperatures above 172° F. Hence, it is high performance in reducing fluid loss at 212° F.

### Conclusion

The expansive properties of the proposed LCM makes it an effective solution not only in bridging and sealing vugs and fractures but also inducing compressive stresses to strengthen the wellbore without damaging the reservoir permeability. It is seen that temperature plays an important role in impacting the performance of LCM and other fluid loss control additives, as the smart LCM is activated above a specific temperature. For instance, at 212° F., the swellable polymer blend exhibited better performance by reducing the cumulative fluid loss by more than half the value, compared to the base mud. The seal is also able to withstand up to 3000 psi differential pressure without breaking. It was also seen that the expansive and chemical properties of the LCM allows it to fill the shape of the fracture if there are enough smart LCM particles to do so. However, if the smart LCM is not activated it will fail to seal the fracture. Characterization of wellbore strengthening by mud cake evolution in fractures, using this approach, can provide more reliable information for selecting best-fit LCM's for a wide range of applications.

Nomenclature

| | |
|---|---|
| Ø_{f}—Frozen portion of the SMP | ∈ₐ^{e}—Entropic active strain |
| pₘ—Mud pressure | ∈_{f}^{T}—Thermal Strain |
| pₚ—Pore Pressure | σₕ—Minimum horizontal stress |
| Tₒ—Initial temperature | σ_{H}—Maximum horizontal stress |
| T_{g}—Glass transitioning temperature | σ_{T}—Thermal stress |
| α—Thermal expansion coefficient of | σ_{SMP}—Total SMP stress release |
| SMP | σ_{Thermal} Thermal SMP stress |
| | release |
| αₐ—Thermal expansion coefficient of | σ_{θ′}—Effective hoop stress |
| active portion of SMP | ΔT—Change in temperature |
| α_{f}—Thermal expansion coefficient of | ∈—Total strain of the SMP |
| frozen portion of SMP | θ—Angle |
| α_{T}—Thermal Constant | h—Thickness of SMP |
| ∈_{f}^{e}—Entropic frozen strain | r_{SMP}—Radius of SMP |
| ∈_{f}ⁱ—Internal energetic strain | |

### References

Abrams, A. 1977: “Mud Design to Minimize Rock Impairment Due to Particle Invasion” Journal of petroleum technology, 29(05), 586-592.
Al-saba, M. T., R. Nygaard, A. Saasen, and O. M. Nes, 2014: “Laboratory Evaluation of Sealing Wide Fractures Using Conventional Lost Circulation Materials,” Paper SPE 170576, presented in SPE Annual Technical Conference and Exhibition, Society of Petroleum Engineers, Amsterdam, The Netherlands.
Al-saba, M. T., R. Nygaard, A. Saasen, and O. M. Nes, 2014: “Lost Circulation Materials Capability of Sealing Wide Fractures,” Paper SPE 170285, presented in SPE Deepwater Drilling and Completions Conference, Society of Petroleum Engineers, Galveston, Tex., USA.
Alsaba, M. T., 2015: “Investigation of Lost Circulation Materials Impact on Fracture Gradient.” PhD Dissertation, Missouri University of Science and Technology.
Alberty, M. W. and McLean, M. R., 2004: “A Physical Model for Stress Cages.” Paper SPE 90493, presented in SPE Annual Technical Conference and Exhibition, Houston, USA.
Arshad U, B. Jain, H. Pardawalla, N. Gupta and A. Meyer, 2014: “Engineered Fiber-Based Loss Circulation Control Pills to Successfully Combat Severe Loss Circulation Challenges During Drilling and Casing Cementing in Northern Pakistan,” Paper SPE 169343, presented at the SPE Latin American and Caribbean Petroleum Engineering Conference, Society of Petroleum Engineers, Maracaibo, Venezuela.
Aston, M. S., Alberty, M. W., McLean, M. R., Jong, H., and Armagost, K. 2004, “Drilling Fluids for Wellbore Strengthening,” Paper-SPE-87130-MS, presented in IADC/SPE Drilling Conference, Dallas, Tex., USA.
Cook J., F. Growcock, Q. Guo, M. Hodder and E. van Oort, 2012: “Stabilizing the Wellbore to Prevent Lost Circulation,” Oilfield Review 23, no. 4, 26-35.
Cook, J., Guo, Q., Way, P., Bailey, L., & Friedheim, J., 2016: “The Role of Filtercake in Wellbore Strengthening” Paper IADC/SPE 17899-MS, presented in IADC/SPE Drilling Conference and Exhibition, Fort Worth, Tex., USA.
Ezeakacha, C. P., Salehi, S., Bi, H, 2017: “How does Rock Type and Lithology Affect Drilling Fluids Filtration and Plastering” Paper AADE-NTCE-094, presented in AADE National Technical Conference and Exhibition, Houston Tex., USA.
Ezeakacha, C. P., Salehi, S., Hayatdavoudi, A., 2016: “Experimental Study of Drilling Fluid's Filtration and Mud Cake Evolution in Sandstone Formations,” ASME. J. Energy Resour. Technol.
Ghalambor, A., Salehi, S., Shahri, M., Karimi, M., 2014: “Integrated Workflow for Loss Circulation Prediction.” Paper-SPE 168123-MS, presented in SPE International Symposium and Exhibition for Formation Damage and Control, Lafayette, La., USA.
Guo, Q., Cook, J., Way, P., Ji, L., & Friedheim, J. E. 2014” “A Comprehensive Experimental Study on Wellbore Strengthening,” Paper IADC/SPE 167957-MS. Presented in IADC/SPE Drilling Conference and Exhibition, Fort Worth Tex., 4-6 March.
Hettema, M., Horsrud, P., Taugbol, K., Friedheim, J., Huynh, H., Sanders, M. W., and Young, S. 2007: “Development of an Innovative High-Pressure Testing Device for the Evaluation of Drilling Fluid Systems and Drilling Fluid Additives within Fractured Permeable Zones.” Paper OMC-2007-082. Presented in Offshore Mediterranean Conference and Exhibition, Ravenna, Italy.
Jain B, M A. Khattak, A M. Mesa, S. Al Kalbani, A. Meyer, S. Aghbari, A. Al-Salti, B. Hennette, M. Khaldi, A. Al-Yaqoubi and H. Al-Sharji, 2013: “Successful Implementation of Engineered Fiber Based Loss Circulation Control Solution to Effectively Cure Losses While Drilling, Cementing and Work Over Operations in Oman,” Paper SPE 166529, presented at the SPE Annual Technical Conference and Exhibition, Society of Petroleum Engineers, New Orleans, USA.
Kumar, A., and Savari, S. 2011: “Lost Circulation Control and Wellbore Strengthening: Looking Beyond Particle Size Distribution.” Paper AADE-11-NTCE-21, presented in AADE National Technical Conference and Exhibition, Houston, Tex., USA.
Li, G. 2014: “Self-healing composites: shape memory polymer based structures.” John Wiley & Sons.
Li, G., and Wang, A., 2016: “Cold, Warm, and Hot Programming of Shape Memory Polymers.” Journal of Polymer Science Part B: Polymer Physics, 54(14), 1319-1339.
Li, G., and Xu, W., 2011: “Thermomechanical Behavior of Thermoset Shape Memory Polymer Programmed by Cold-Compression: Testing and Constitutive Modeling.” Journal of the Mechanics and Physics of Solids, 59(6), 1231-1250.
Li, G., and Nettles, D., 2010: “Thermomechanical Characterization of a Shape Memory Polymer Based Self-Repairing Syntactic Foam.” Polymer, 51(3), 755-762.
Mansour, A. K., Taleghani, A. D, and Li, G., 2017: “Smart Expandable LCMs; A Theoretical and Experimental Study.” Paper AADE-17-NTCE-074, presented at the 2017 AADE National Technical Conference and Exhibition in Houston, Tex., USA.
Mansour, A. K., Taleghani, A. D., and Li, G., 2017: “Smart Lost Circulation Materials for Wellbore Strengthening.” Paper ARMA 17-0492, presented at the 51^{st} US Rock Mechanics/Geomechanics Symposium in San Francisco, Calif., USA.
Peng, S. and Zhang, J., 2007: “Engineering geology for underground rocks.” Springer Science & Business Media.
Ratna, D. and Karger-Kocsis, J., 2008: “Recent advances in shape memory polymers and composites: a review.” Journal of Materials Science, 43, 254-269.
Salehi, S. 2012: “Numerical Simulations of Fracture Propagation and Sealing: Implication for Wellbore Strengthening.” PhD dissertation, Department of Geological Sciences and Engineering, Missouri University of Science and Technology. USA.
Santos, L., A. Dahi Taleghani, Li, G., 2016: “Smart Expandable Proppants to Achieve Sustainable Hydraulic Fracturing Treatments,” Paper SPE 181391-MS presented in SPE Annual Technical Conference & Exhibition in Dubai, UAE.
Santos, L., A. Dahi Taleghani, Li, G., 2017: “Expandable Diverting Agents to Improve Efficiency of Refracturing Treatments” Paper-URTeC 2697493, presented in the Oral presentation at the Unconventional Resources Technology Conference in Austin, Tex., USA.
Siskind, R. D., & Smith, R. C., 2008: “Model development for shape memory polymers.” In The 15th International Symposium on: Smart Structures and Materials & Nondestructive Evaluation and Health Monitoring (pp. 69291H-69291H). International Society for Optics and Photonics.
Taleghani, A. D., Li, G., & Moayeri, M., 2016: “The Use of Temperature-Triggered Polymers to Seal Cement Voids and Fractures in Wells.” SPE-PAPER-181384-MS Society of Petroleum Engineers.
Vickers, S., Cowie, M., Jones, T., and Allan, J. T., 2006: “A New Methodology that Surpasses Current Bridging Theories to Efficiently Seal a Varied Pore Throat Distribution as Found in Natural Reservoir Formations,” paper AADE-06-DF-HO-16 presented at the 2006 AADE Fluids Conference held in Houston, Tex., USA, 11-12 April.
Wang, A., and Li, G., 2015: “Stress Memory of A Thermoset Shape Memory Polymer.” Journal of Applied Polymer Science, 132(24), 42112.
White, R. J., 1956: “Lost-circulation Materials and their Evaluation,” In Drilling and Production Practice. American Petroleum Institute.
Whitfill, D. 2008: “Lost Circulation Material Selection, Particle Size Distribution and Fracture Modeling with Fracture Simulation Software.” SPE-115039-MS, IADC/SPE Asia Pacific Drilling Technology Conference and Exhibition, Jakarta, Indonesia, 25-27 August.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

While only a few embodiments of the present disclosure have been shown and described herein, it will become apparent to those skilled in the art that various modifications and changes can be made in the present disclosure without departing from the spirit and scope of the present disclosure. All such modification and changes coming within the scope of the appended claims are intended to be carried out thereby.

We claim at least the following:

1. A method of reducing loss circulation in an oil and gas well, comprising:
disposing a loss circulation material including a shape memory polymer in a programed state into fractures in a well during drilling, wherein the shape memory polymer has an activated state and a programed state, wherein in the programed state of the shape memory polymer has a first diameter, wherein in the activated state of the shape memory polymer has a second diameter, wherein the second diameter is greater than the first diameter, wherein the shape memory polymer in the programed state will convert to the shape memory polymer in the activated state when a first temperature is applied to the shape memory polymer in the programed state, wherein the loss circulation material is exposed to the first temperature in the oil and gas well;
exposing the loss circulation material to the first temperature converts the shape memory polymer in the programed state to the shape memory polymer in the activated state upon, wherein the expansion of the shape memory polymer fills a portion of the fracture, wherein a subsequent change in the temperature of the oil and gas well to be different than the first temperature does not alter the activated state of the shape memory polymer; and
reducing the loss circulation in the oil and gas well.

2. The method of claim 1, wherein the first temperature is about 70 to 170° C.

3. The method of claim 1, wherein the shape memory polymer has a core and a layer of polymer around the core.

4. The method of claim 3, wherein the core is selected from a group consisting of: a grain of sand, bauxite, and ceramic.

5. The method of claim 1, wherein the shape memory polymer is a solid polymer material in the form of fiber, particulates, or a mixture thereof.

6. The method of claim 1, wherein the loss circulation mixture includes the shape memory polymer and a second loss circulation component.

7. The method of claim 1, wherein the first diameter is about 50 μm to 0.5 mm, and wherein the second diameter is about 100 μm to 1 mm, wherein the second diameter is greater than the first diameter.

8. The method of claim 1, wherein the shape memory polymer in the programmed state is particulate, and wherein the shape memory polymer in the activated state is an integrated wafer.

9. The method of claim 1, wherein the shape memory polymer is an ionomer of ethylene acid copolymer.

10. The method of claim 9, wherein the shape memory polymer is Surlyn® 8940.

11. The method of claim 1, wherein the expansion of the shape memory polymer releases a stress force of about 5-20 MPa.

12. The method of claim 1, wherein the first temperature is a temperature of a wellbore bottomhole.

13. The method of claim 1, wherein the shape memory polymer is a thermoset or thermoplastic polymer.

14. The method of claim 1, wherein the shape memory polymer further comprises a curing agent and a liquid resin.

15. The method of claim 8, wherein the particulate shape memory polymer in the programmed state is manufactured with diameters from 50 μm to 0.5 mm.

16. The method of claim 1, wherein the shape memory polymer comprises a thermoset or thermoplastic polymer reinforced by fiber.

17. The method of claim 16, wherein the fiber is selected from the group consisting of: a metallic fiber, a ceramic fiber, a polymeric fiber, a mineral fiber, and a combination thereof.

18. The method of claim 16, wherein the fiber is about 1% to about 50% of the shape memory polymer.

19. A method of strengthening a wellbore in an oil and gas well, comprising:
disposing a loss circulation material including a shape memory polymer in a programed state into fractures in a well during drilling, wherein the shape memory polymer has an activated state and a programed state, wherein in the programed state of the shape memory polymer has a first diameter, wherein in the activated state of the shape memory polymer has a second diameter, wherein the second diameter is greater than the first diameter, wherein the shape memory polymer in the programed state will convert to the shape memory polymer in the activated state when a first temperature is applied to the shape memory polymer in the programed state, wherein the loss circulation material is exposed to the first temperature in the oil and gas well; and
exposing the loss circulation material to the first temperature converts the shape memory polymer in the programed state to the shape memory polymer in the activated state upon, wherein the expansion of the shape memory polymer fills a portion of the fracture, wherein a subsequent change in the temperature of the oil and gas well to be different than the first temperature does not alter the activated state of the shape memory polymer,
wherein expansion of the shape memory polymer strengthens the wellbore relative to the strength prior to expansion of the shape memory polymer.

20. The method of claim 19, further comprising removing the shape memory polymer by exposing the shape memory polymer to a solvent.
